(19) United States
(12) Patent Application Publication
(10) Pub. No.: US 2026/0261190 A1
(43) Pub. Date: Sep. 3, 2026

(54) AN AIR-CORE-STATOR ELECTRIC MACHINE WITH SUPERCONDUCTING CIRCUITS AND SHIELDING

(71) Applicant: THE REGENTS OF THE UNIVERSITY OF CALIFORNIA, Oakland, CA (US)

(72) Inventors: Leila Parsa, Santa Cruz, CA (US); Keith Corzine, Santa Cruz, CA (US); Saeid Saeidabadi, Santa Cruz, CA (US); Tim Haugan, Dayton, OH (US); Christopher Kovacs, Columbus, OH (US)

(73) Assignees: THE REGENTS OF THE UNIVERSITY OF CALIFORNIA, Oakland, CA (US); Air Force Research Laboratory, Rome, NY (US)

(21) Appl. No.: 18/867,158

(22) PCT Filed: May 15, 2023
(86) PCT No.: PCT/US2023/067007

§ 371 Date: Nov. 19, 2024

Related U.S. Application Data
(60) Provisional application No. 63/344,516, filed on May 20, 2022.

(51) Int. Cl. H02K 55/02; H02K 3/24; H02K 3/30; H02K 16/02

(52) U.S. Cl. CPC H02K 55/02; H02K 3/24; H02K 3/30; H02K 16/02; H02K 2213/03

(57) ABSTRACT

A electric machine comprising at least one rotor, high-temperature superconducting field coils, and an air-core stator. In one or more embodiments, superconducting shielding is placed in the interpole locations of the at least one rotor.

### CROSS REFERENCE TO RELATED APPLICATIONS

This application claims the benefit under 35 U.S.C. Section 119 (e) of the following co-pending and commonly-assigned U.S. Provisional Application Ser. No. 63/344,516, filed on May 20, 2022, by Leila Parsa, Keith Corzine, Saeid Saeidabadi, Tim Haugan, and Chris Kovacs, entitled “AN AIR-CORE STATOR FLUX SWITCHING MACHINE WITH SUPERCONDUCTING CIRCUITS AND SHIELDING,” Attorney's Docket Number 284.0013USP1; which application is incorporated by reference herein.

### STATEMENT REGARDING FEDERALLY SPONSORED RESEARCH AND DEVELOPMENT

This invention was made with government support under Grant Number DE-AR0001355, awarded by the U.S. Department of Energy. The government has certain rights in the invention.

### BACKGROUND OF THE INVENTION

### 1. Field of the Invention

The present disclosure relates to electric machines and methods of making the same.

### 2. Description of the Related Art

Many applications for electric motors necessitate high power density. For example, aircraft propulsion requires low mass at a specific power output. Aviation industries have made extensive progress in exploring possible ways of reducing aircraft energy consumption [18]. The focus on completely electrifying aircraft transportation is widely gaining momentum in accomplishing the objective of the all-electric aircraft concept [19]-[20]. Among several possible propositions available towards decarbonizing the aviation sector; the use of all-electric power train is found to be favorable in developing a clean energy aircraft design [21]. However, the existing electric machines suffer from relatively low power densities when compared to their traditional propulsion systems. This brings about a research opportunity for electric machine designers, stipulating substantial improvement in both power density and efficiency of the machine [18]. The present invention satisfies this need.

### SUMMARY OF THE INVENTION

Examples of the inventive subject matter of the present invention include, but are not limited to, the following.
1. An electric machine, comprising:
an air core stator comprising field coils and armature coils, wherein the field coils comprise a superconductor; and
at least one rotor coupled to the air core stator.
2. The electric machine of example 1, further comprising a superconducting shielding between poles of the at least one rotor.
3. The electric machine of example 1 or 2, wherein:
the at least one rotor further comprises:
   a first rotor comprising first rotor poles and first air spaces or non-magnetic slots between the first rotor poles; and
   a second rotor comprising second rotor poles and second air spaces or non-magnetic slots between the second rotor poles, the first rotor and the second rotor comprising a material having a lower reluctance than air; wherein the second rotor is positioned concentrically or axially inside the first rotor such that the second rotor poles face the first air spaces or non-magnetic slots; the air core stator:
   is disposed between the first rotor and the second rotor,
   comprises a core consisting essentially of air; and
   contains a plurality of pairs of coils attached to the stator, each pair comprising at least one of the field coils magnetically coupled to one of the armature coils.
4 The electric machine of example 3, wherein the pairs of coils are attached to the air core stator such that a magnetic flux generated by each of the pairs of coils is diverted into at least one of the first rotor poles or at least one of the second rotor poles.
5 The electric machine of example 3 or 4, further comprising superconducting shielding placed at interpole locations between the rotor poles of the at least one rotor.
6. The electric machine of example 5, further comprising the superconducting shielding covering at least the first air spaces or non-magnetic slots or the second air spaces or non-magnetic slots between the rotor poles, so as to aid diversion of the magnetic flux into the rotor poles.
7. The electric machine of any of the examples, wherein the superconducting shielding comprises a tape comprising at least one of a machined bulk melt textured solid high temperature superconductor (HTS), pressed and sintered polycrystalline HTS, a laminated HTS coated-conductor composite stack, or a heterostructure comprising a non-superconductor layer between superconductor layers.
8. The electric machine of any of the examples, wherein:
the superconducting shielding comprises a layer or tape having a solid superconductive cross-section perpendicular to a magnetic flux in interpole regions, comprising the air spaces or non-magnetic slots between the rotor poles, to prevent the magnetic flux leaking through the superconductive shielding, and
any gaps in the superconductive shielding perpendicular to the magnetic flux in the interpole regions are smaller than a penetration depth of the superconducting shielding to prevent penetration of the magnetic flux into the gaps.
9. The electric machine of any of the examples, wherein the superconducting shielding comprises a high temperature superconductor (HTS) comprising at least one of a cuprate, an iron-based superconductor, or MgB₂ having a critical temperature above 20 Kelvin (K).
10. A motor comprising the electric machine of any of the examples 1-9, further comprising:
a circuit connected to the field coils and the armature coils, wherein, for each of the pairs of coils:
the armature coils generate magnetic flux in response to a first current inputted from the circuit, and
the field coil generate a stator magnetic pole aligned along a circumferential direction of the air core stator in response to a second current inputted from the circuit, the stator magnetic pole causing a diversion of the magnetic flux into the at least one of first rotor poles or the second rotor poles, and
the diversion of the magnetic flux along the stator magnetic poles and into the at least one of the rotor poles causes a rotation of at least one of the first rotor or the second rotor so as to increase alignment of at least one of the rotor poles with the stator magnetic pole, thereby outputting torque to a component coupled to the rotation.
11. A power train for an aircraft or vehicle comprising the motor of claim 11, or turbine powered by the motor of claim 11, or the motor of claim 11 configured for providing motive power for driving a vehicle wheel, a transmission, propelling an aircraft, or rotating the turbine.
12. An electric generator comprising the electric machine of any of the examples, further comprising a circuit connected to the field coils and the armature coils, wherein, for each of the pairs of the coils,
the field coils form stator magnetic poles aligned along a circumferential direction of the stator, the stator magnetic poles generating a magnetic flux, in response to a first current inputted from the circuit, and
a second current is induced in the armature coils and outputted to the circuit in response to an interaction of the rotor poles with the magnetic flux caused by a rotation of at least one of the first rotor or the second rotor.
13. The electric machine of any of the examples, further comprising a circuit connected to the pairs of coils generate a magnetic flux and switching the magnetic flux between the rotor poles in response to sequential excitation of the pairs of coils by the circuit.
14. The electric machine of example 13, wherein the coils are positioned and the sequential excitation are such that the switching comprises a reversal of the magnetic flux so that the linkage of the magnetic flux has a polarity reversing periodically between:
a first direction from one of the first rotor poles to one of the second rotor poles, to
a second direction from one of the second rotor poles to one of the first rotor poles.
15. The electric machine of any of the examples, wherein:
the armature coil comprises or consists essentially of at least one of aluminum Litz wire or copper Litz wire,
an exterior of the wires in the field coil comprises a coating comprising or consisting essentially of a superconductor, or the filed coil comprise or consists essentially of a superconductor, and
the at least one rotor comprises or consists essentially of an iron-cobalt vanadium alloy or a laminated iron-cobalt vanadium alloy.
16. The electric machine of any of the examples, further comprising a cryogenic cooling system thermally coupled to the air core stator for cooling the armature coil and the field coil to a temperature of 20 Kelvin or above.
17. The electric machine of example 16, wherein the cooling system comprises a plurality of coolant manifolds mechanically supporting each of the pairs of coils, wherein each of the coolant manifolds comprise an electrically insulating polymer separating and supporting the field coils and armature coil in each pair and a coolant system thermally coupling the coils to a flowing coolant.
18. The electric machine of example 3, wherein:
the first rotor, the second rotor, and the stator comprise concentric annular rings about a central axis,
for each of the pairs of the coils,
   the field coil comprises a field winding disposed within, surrounded by, or inside an opening of the armature coil comprising an armature winding,
   armature wires of the armature winding are concentric about an armature axis oriented along a radial direction from the central axis, and
   field wires of the field winding are concentric about a field axis oriented along a circumferential direction perpendicular to the radial direction, and
   a core of the field coil comprises or consists essentially of air, or the field coil is coiled around air.
19. The electric machine of example 18, wherein:
each of the pairs of coils comprises a plurality of the field coils disposed with, surrounded by, or inside the opening of the armature coil, and
the first rotor poles and the second rotor poles comprise teeth spaced a half pitch apart.
20. The electric machine of any of the examples, comprising:
20 first rotor poles and 20 second rotor poles and 15 pairs of the coils, or
7 first rotor poles and 7 second rotor poles and 6 pairs of the coils, or
16 first rotor poles and 16 second rotor poles and 12 pairs of the coils, or
12 first rotor poles and 12 second rotor poles and 9 pairs of the coils.
21. The electric machine of example 3, further comprising a circuit connected to the pairs of coils, wherein:
the armature coil in each of the pairs of the coils, associated with a given one of a plurality of phases excited by the circuit, are electrically connected in series for simultaneous excitation by the circuit with a current, and
the current in each of the phases is out of phase with the current in another of the phases.
22. The electric machine of example 21, wherein all the field coils are connected in series.
23. The electric machine of example 21, comprising a number Nₚₒₗₑ of the rotor poles, a number Nₛₗₒₜ of the pairs of coils, and a number m of the phases, wherein

$${N}_{pole} = {N}_{s l o t} ( 2 \pm \frac{n}{2 m} )$$

Nₚₒₗₑ is optionally in a range of 7-20 for example.
24. The electric machine of any of the examples, wherein the electric machine comprises a flux switching machine comprising a plurality of the at least one rotor and the air core stator between a pair of the rotors.
26. The electric machine of example 24, wherein the flux switching machine comprises a flux reversal machine.
27. The electric machine of claim 1, wherein the electric machine comprises an axial machine (e.g., axial flux machine) wherein magnetic flux generated by the coils is along an axial direction parallel to an axis of rotation of the rotors.
28. The electric machine of claim 1, wherein the electric machine comprises a radial machine (e.g., radial flux machine) wherein magnetic flux generated by the coils is along a radial direction perpendicular to an axis of rotation of the at least one rotor.

### BRIEF DESCRIPTION OF THE DRAWINGS

Referring now to the drawings in which like reference numbers represent corresponding parts throughout:

FIG. 1a-c. Cross-sectional diagrams of the example Flux Switching Machines (FSMs) with High Temperature Superconductor (ITS) field coils and different pole slot combinations. (a). The 15-slot/20-pole FSM; (b). The 6-slot/7-pole FSM; (c). 12 pole 9 slot FSM.

FIG. 2a-c Cross sectional Schematics of Structure of Double-rotor FSM with HTS field coil and superconducting shielding (a) 7 pole/6 slot DRFSM: (b) 20 pole/16 slot; (c). 16 poles 12 slot DRFSM, FIG. 2d. Oblique view of the geometry of a Double rotor-FSM with HTS coils and superconducting shield.

FIG. 3a. Close-up schematic of a FSM design with shield, wherein the air gap can be 1 mm. FIG. 3b shows the detailed dimensions of the DRFSM-HTS with shield, wherein each air gap is g=0.5 mm.

FIG. 4. Hiperco50 soft-iron material characteristics. (a) B-H characteristic; (b) Iron losses at various frequencies [22]. Among various core materials used in the design of electric motors, Hiperco 50 possesses the highest magnetic saturation of 2.4T. This feature of Hiperco50 enables larger flux density in the air gaps and significantly increases the performance of the electric machine. FIG. 4c Engineering current density of YBCO at different temperatures [23]. It is seen that the engineering current density decreases with increasing magnetic field.

FIG. 5. (a) Topology of a 20 pole/15 slot double-rotor FSM motor; (b) Field coils for 20 pole/15 slot, 12 pole/9 slot, and 12 pole/16 slot double-rotor FSM motor (c) armature coils for 20 pole/15 slot. 12 pole/9 slot and 12 pole/16 slot double-rotor FSM motor. The stator of 12 pole/9 slot has 9 field coils and 3 armature coils connected in series per phase while the stator of 16 pole/12 slot has 12 field coils and 4 armature coils connected in series per phase. (d) Principle of operation of DRFSM with shield.

FIG. 6. Back EMF for different number of rotor poles for a 15 slot geometry.

FIG. 7a. Algorithm flowchart of Je calculation for field coils.

FIG. 7b. Flowchart of Optimization (Genetic algorithm).

FIG. 8. Different designs (a) power density v. outer radius (b) power density v. inner radius, (c) power density v. inductance, (d) torque ripple vs. inductance, for 20 Pole 15 slot FSM with shield; (e) power density vs. inductance (f) torque ripple vs. inductance (g) power density vs. outer radius (h) power density vs. inner radius for double rotor FSM with 20 pole 15 slot without shield.

FIG. 9. Power density versus distance of superconducting shield from motor rings (b) torque ripple versus distance of superconducting shield from motor rings (c) inductance versus distance of superconducting shield from motor rings.

FIG. 10a-c. Variation of stator tooth width and rotor tooth width and their impact on (a) power density (b) torque ripple (c) inductance. FIG. 10d-f. Variation of field coil core width and rotor tooth height and their impact on (d) power density (e) torque ripple (f) inductance. FIG. 10g-i. Variation of field coil slot area width and length and their impact on (g) power density (h) torque ripple (i) inductance. FIG. 10k-m Variation of thickness of inner and outer rotor and their impact on (k) power density (l) torque ripple (m) inductance (for 20 pole 15 slot without shield). 10(n)-(o) for 20 pole 15 slot with shield. Power density versus (n) stator tooth width and rotor tooth width (m) field coil core width and rotor tooth height (o) field coil slot area width and field coil slot area length (p) thickness of the inner rotor ring and thickness of the outer rotor ring, for 20 pole 15 slot with shield.

FIG. 11. Numerical Finite Element analysis of a 20 pole 15 slot double-rotor FSM motor. FE model (a) 250 kW (b) 1 MW; Schematic of superconductors exposed to a spatially uniform, time-varying magnetic field, Hₑ(t), directed as indicated by the arrowed lines for (c) tape of width t (parallel field configuration) and (d) tape of thickness δ (perpendicular); Back-EMF (e) 250 kW (f) 1 MW; Flux linkage (g) 250 kW (h) 1 MW; Torque (i) 250 kW (j) 1 MW; Core losses of FSM motor under (k) take-off and (l) cruise conditions.

FIG. 12 Numerical analysis of 20 pole 15 slot double rotor FSM motor with HTS but without shield (a) Back-EMF (b) Torque; (c) FE model showing flux density of the motor (d) L_{d} and L_{q} of proposed motors (e) magnetic field on the field coil (f) harmonic spectrum of magnetic field on the field coil and armature winding. FIG. 12g. Losses and Efficiency of the proposed motor with different widths of YBCO filaments.

FIG. 13. Numerical Analysis of 20 pole 15 slot double-rotor FSM (a) full-load condition with shield (b) full-load condition without shield; Flux lines of proposed DRFSM (c) full-load condition with shield and (d) full-load condition without shield; (e) Back-EMF with superconducting shield; (f) Back-EMF without superconducting shield; (g) Torque with superconducting shield; (h) Torque without superconducting shield (i) Inductance of 20-pole/15-slot DRFSM with superconducting shield; (j) loss and efficiency.

FIG. 14. Numerical analysis of 16 pole 12 slot DRFSM. Flux density and lines of the motor (a) with shield (b) flux density and lines of motor without shield. Flux linkage (c) with shield (d) without shield. Back EMF with shield (e) and without shield (f). Torque with shield (g) and without shield (h); and (i) L_{d} and L_{q}

FIG. 15a. FE model of 12 pole/9 slot double-rotor FSM showing field lines/flux path. 15b. 16-pole/12-slot double-rotor FSM showing field lines/flux path for comparison.

FIG. 15c FSM back-EMF under cruise and take-off conditions.

FIG. 15d Electromagnetic torque (rated) under take-off conditions.

FIG. 15e Electromagnetic torque under cruise conditions.

FIG. 15f Flux linkages under take-off and cruise conditions for a 16 poles/12 slot FSM

FIG. 15g-h Core losses of FSM motor under take-off (FIG. 15g) and cruise conditions (FIG. 15h).

FIG. 15i. The losses of the FSM under take-off and cruise conditions for 16 pole/12 slot design.

FIG. 16 (a) DRFR with superconducting shield and field coils (b) geometry details of proposed motor (c) Principle operation of a proposed DRFRM with shield.

FIG. 17 (a) flux density and flux lines of the DRFRM motor with shield (b) Flux density and flux lines of the DRFRM motor without shield.

FIG. 18. Flux linkage of DRFRM with shield and without shield.

FIG. 19 (a) Back-EMF of DRFRM with shield and wiout shield. (b) Torque of DRFRM without shield and wihout shield.

FIG. 20. L_{d} and L_{q} of DRFRM.

FIG. 21a. Efficiency and loss of proposed DRFRM with different YBCO stand's width

FIG. 21b. Table XIV.

FIG. 22a.Thermal management system of electric machines showing how the armature and field coils are mechanically supported.

FIG. 22b. Aircraft power train comprising a motor according to one or more embodiments.

FIG. 22c. Vehicle (e.g., truck, car) power train comprising a motor according to one or more embodiments.

FIG. 23. Flowchart illustrating a method of making an electric machine.

FIG. 24. Schematic of an axial electric machine (e.g., axial flux machine).

Some of the drawings are better understood when provided in color and the specification makes reference to color versions of the drawings. Applicant considers the color versions of the drawings as part of the original disclosure and reserves the right to provide color versions of the drawings in later proceedings.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

### TECHNICAL DESCRIPTION

Electric machines according to embodiments described herein comprise at least one rotor and an air-core stator containing the armature windings and field coil windings. The field coil winding optionally comprise a high-temperature superconducting (HTS). The employment of the air-core stator reduces the weight of a machine, increasing the overall power density. Further, the air-core stator allows high flux density without concern for saturation or core losses (alternatively stated, the air core enables employment of the HTS field coils with higher ampere-turns without having concern for the stator saturation). Moreover, the HTS field coils may generate controllable and large flux densities that are tailored for the implementation of the air core stator. In addition, high-temperature superconducting shielding may be placed within the rotor in interpole locations further increasing the power density Such an electric machine may be used in applications necessitating high power density, or low mass at a specific power output. The design, FEA analysis, and construction methods are further detailed herein.

### First Example: Air-Core Flux Switching Machine

### a. Structure without Shield

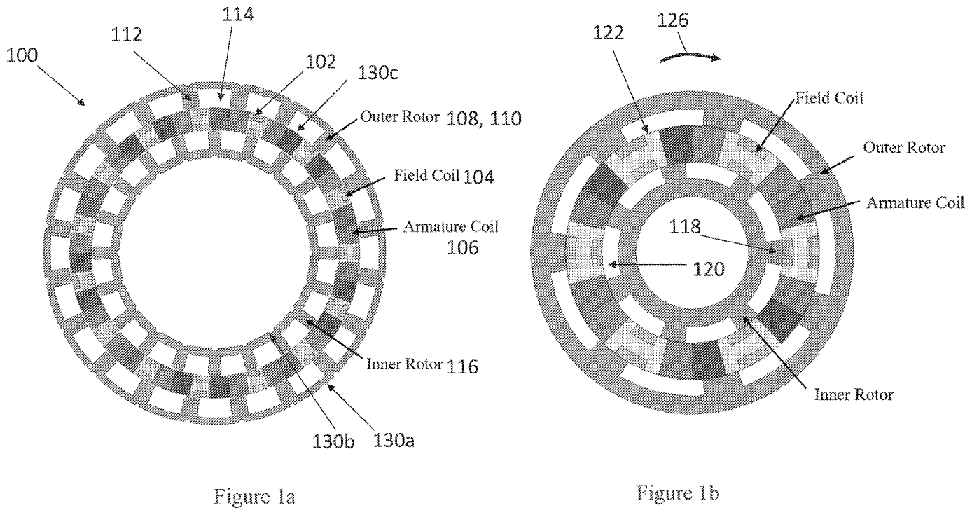

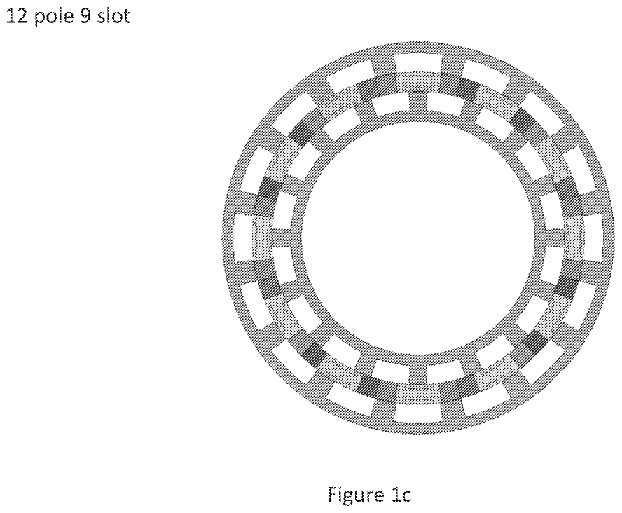

FIG. 1 illustrates example electric machines comprising a flux-switching machine (FSM), wherein the at least one rotor comprises a first rotor comprising first rotor poles and first air spaces or non-magnetic slots between the first rotor poles; and a second rotor comprising second rotor poles and second air spaces or non-magnetic slots between the second rotor poles. The first rotor and the second rotor each comprise a material having a lower reluctance than air; and the second rotor is positioned concentrically inside the first rotor such that the second rotor poles face the first air spaces or non-magnetic slots.

The air core stator is disposed between the first rotor and the second rotor, and comprises a core consisting essentially of air. A plurality of pairs of coils are attached to and located on the stator, each pair comprising at least one field coil magnetically coupled to an armature coil. The field coil comprises wiring comprising a high temperature superconductor.

The FSM has advantages over other types of machines in that the armature and field windings are both located on the stator. This yields simpler access to the windings and allows easier cooling techniques. The design is unique in that it contains HTS windings and an air-core stator. The rotor is a dual structure with inner and outer rotor pieces; having their teeth a half-pitch apart.

FIG. 1 illustrates 15-slot/20-pole and 6-slot/7-pole embodiments. As seen in FIG. 1, the field coil polarity depends on the slot/pole combination. Specifically, the polarity is the same for all field coils in the 15-slot/20-pole design and alternates in the 6-slot/7-pole design.

The material of the rotors can be laminated Hiperco50. This material has a high saturation point and very low magnetic losses.

b. Structure with Shield

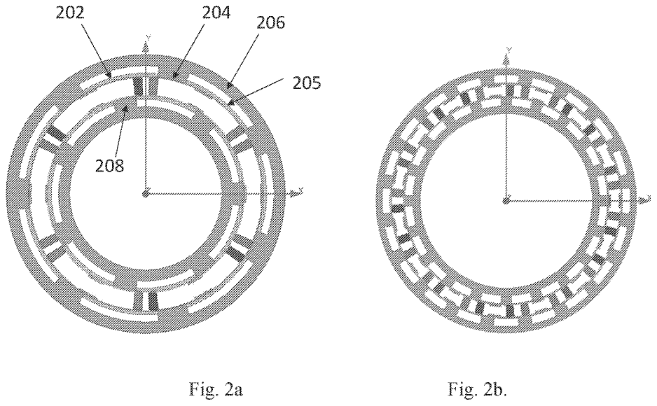

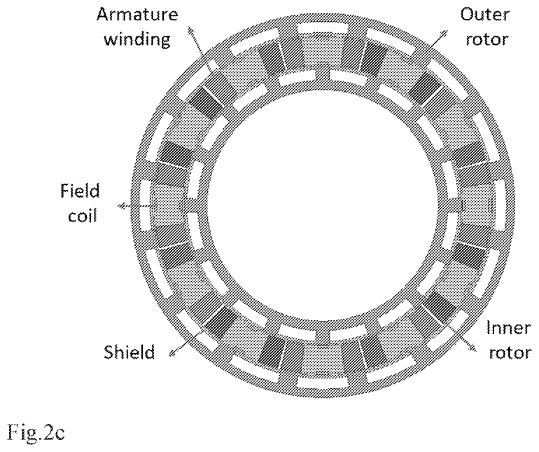

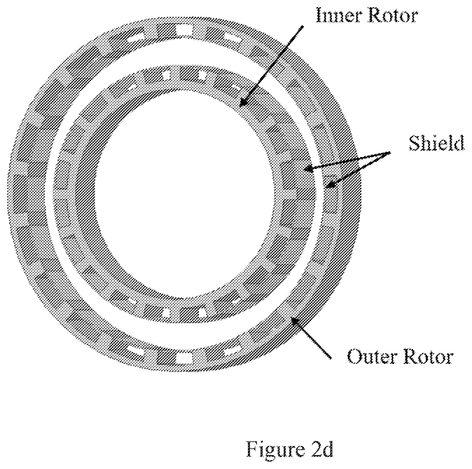

FIG. 2 illustrates a double rotor FSM with superconducting shielding, which can further enhance and improve the power density of the FSM. The superconducting shields provide effective guidance to the magnetic flux towards the rotor teeth, avoiding any leakage of flux. The minimization of leakage flux eventually increases the power density of the machine. Thus, the double-rotor FSM with superconducting shielding offers significant improvement in power density compared to a machine with similar pole-slot configurations without shields.

The FSM with HTS coils and superconducting shielding has a high power density. As an example, the power density for the 15-slot/20-pole design at 1 MW is 102 kW/kg.

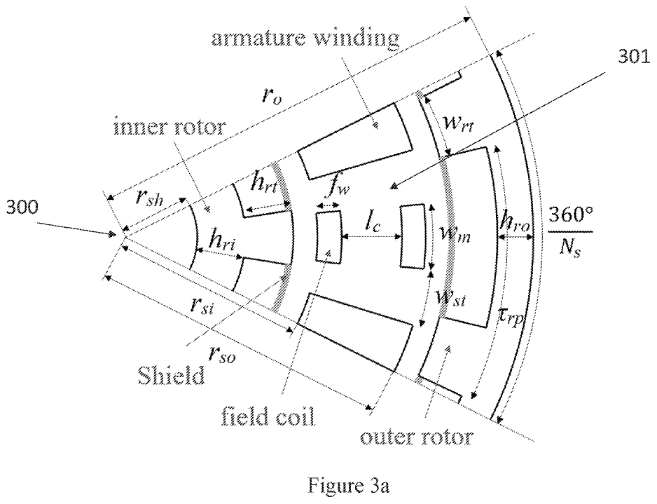

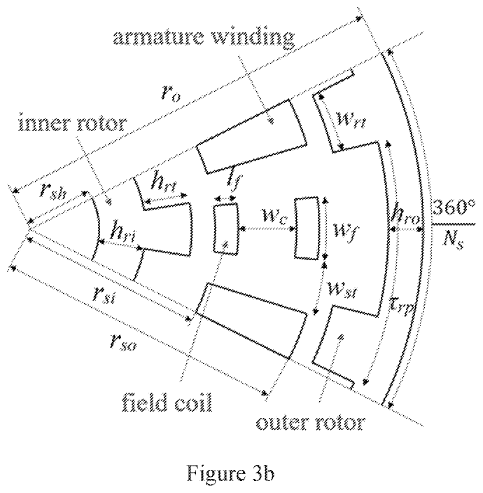

FIG. 3 illustrates a partial cross section of the double-rotor FSM with HTS-coils with superconducting shielding, comprising an inner and outer rotor, air-core stator, armature winding, field coils and the superconducting shield on the rotor at interpole locations.

The shielding can comprise of machined bulk melt textured solid HTS, pressed and sintered polycrystalline HTS, or laminated HTS coated-conductor composite stack. In some examples, it may be critical to have a near solid superconductive cross-section perpendicular to the magnetic flux in the interpole region to prevent flux leakage through the superconductive shielding. Any gaps in the superconductive shielding perpendicular to the magnetic flux in the interpole region, which may be required due to manufacturing and assembly, should be kept smaller than the penetration depth of the superconductor to prevent flux penetration (penetration depth is typically 100s of nanometers for HTS). The HTS shielding chosen can range in composition from HTS cuprates, iron-based HTS, and MgB₂ depending on the thermal management system. The magnetic flux density would ideally maintain below the first superconductive critical magnetic field, B_{cl}, to ensure perfect shielding with no dissipative internal fluxon mixed state when AC magnetic fields are applied. However, B_{cl} is generally only a few mT for HTS. One way around this is to use superconductor/non-superconductor/superconductor (S-N-S) layered heterostructures to significantly enhance magnetic shielding performance [13,14]. These heterostructures may be fabricated, or may be intrinsic. An example of an intrinsic S-N-S structure is a bulk textured HTS cuprate at elevated temperatures with very weakly coupled A-B copper oxide planes resulting in pancake fluxon dynamics [15-17].

### b. Example Rotor Structure

A double rotor structure (as illustrated in FIGS. 1 and 2) offers maximum torque density to the output to the machine [2]. The two rotors of the machine are displaced by half a pole-pitch in order to maintain symmetry of flux flow. When present, superconducting shielding is placed between two adjutant poles to divert the flux to pass mostly through rotors.

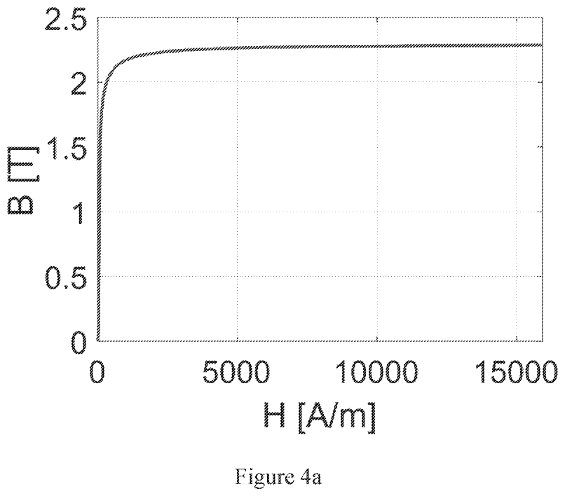

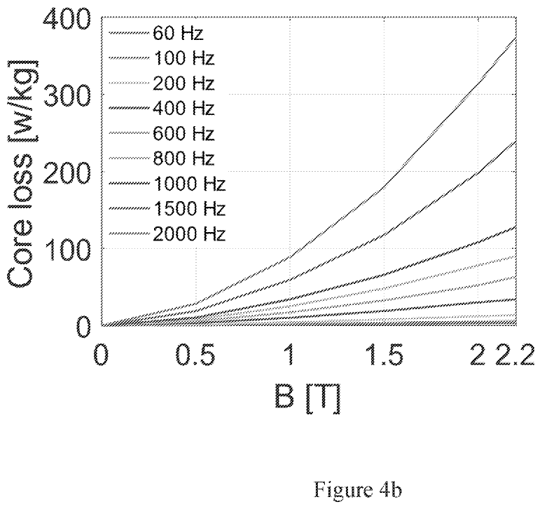

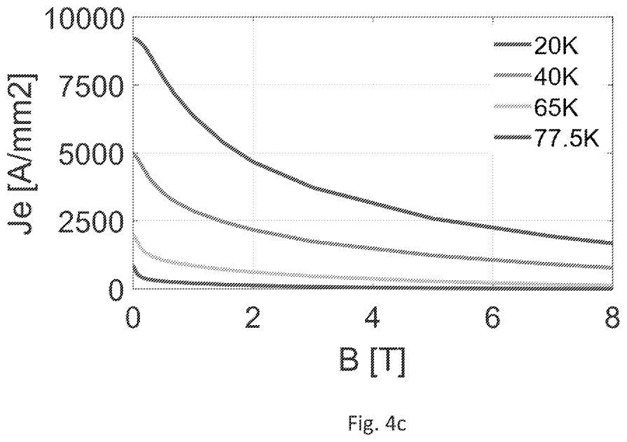

Among various existing core materials [3] and [4] used in the design of electric motors, one or more embodiments employ a laminated HiperCo-50 soft iron magnetic material. A HiperCo-50 is an iron-cobalt vanadium alloy possessing the highest magnetic saturation of 2.4T, with less core loss than silicon steel sheet [22]. The B-H curves and iron loss curves of HiperCo50 under different operating frequencies are shown in FIGS. 4a and 4b (data for rotor thickness comprising laminated Hiperco-50 with a thickness of 0.15 mm).

The existence of high flux density saturation level (~2.4 T), enabling larger flux density in the air gaps, in addition to low magnetic hysteresis losses, significantly boosts the performance efficiency of the electric machines, particularly for those deployed in aerospace applications. These special characteristic features of HiperCo50 make HiperCo50 a preferred iron-core material for the machine.

c. Stator Structure

The example constructions illustrated in FIGS. 1-3 employ both the armature conductors and field coils on the same part of the machine, while the rotor is just used as a robust structure. In this case, both the armature windings and field coils are wound within the stator and they are stationary, which simplifies the thermal management simpler for such motors operating under cryogenic temperatures in all electric power train applications.

As discussed above, the employment of air-core stator, provides reduction in the weight of a machine, improving its effective power to mass ratio and enhancing the overall power density of the motor. Using air as the stator core also improves the efficiency of the machine, since the stator core losses are absent. In addition, the field coils mounted on the air core stator are also not limited to the maximum excitation value (since the absence of material does not restrict to any saturation).

The electric machines characterized herein utilize Yttrium Barium Copper Oxide (YBCO) high temperature superconducting (HTS) coils for field excitation since they have good Jc−B characteristics and availability of wide temperature margins [8] and [9] (e.g., operating at 65K or below). FIG. 4(c) shows the engineering current density (Je) of YBCO versus perpendicular flux density to the tape at different temperatures. As can be seen, Je varies dramatically with perpendicular flux density to the tape. Therefore, the perpendicular flux density determines the maximum allowable field current. In addition, the AC loss is also reduced by making the YBCO tapes in a smaller filament structure using the laser-scribing technique [24].

The embodiments studied herein further utilize Aluminum Litz wire (ALW) at 95K for armature winding wound around the field coils of the stator, because ALW at 95K or below (cryogenic temperatures) has less resistivity, smaller loss, and high achievable current density [10]. ALW's mass density (about one third of Copper) and along with its high current density help increase the power density of the electric machine.

d. Assembly Configurations

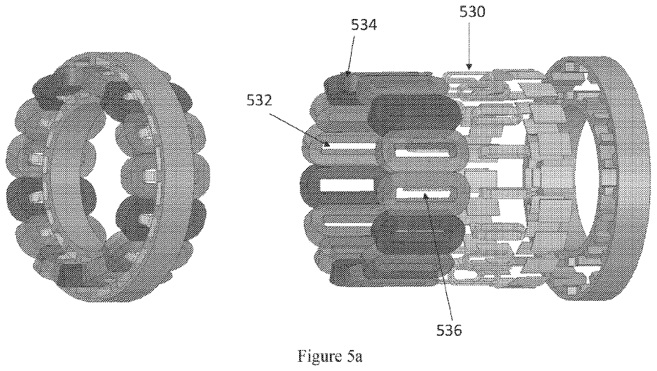

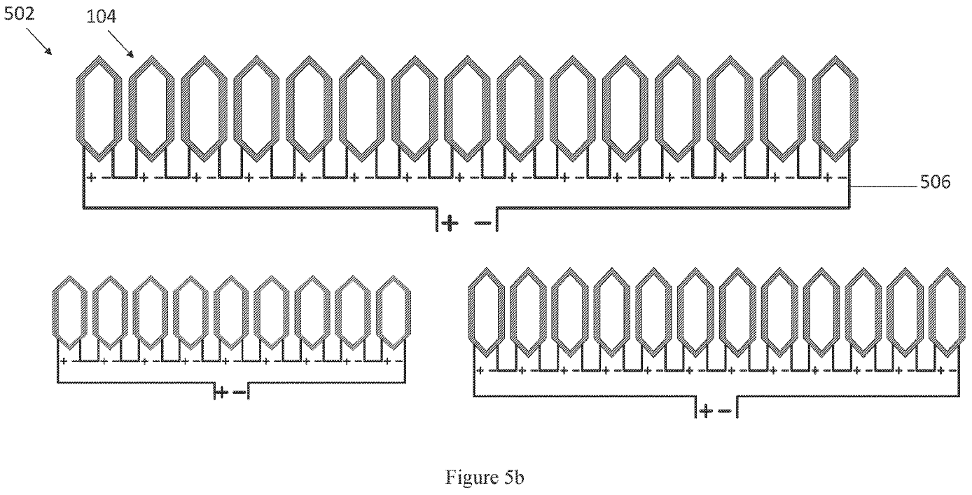

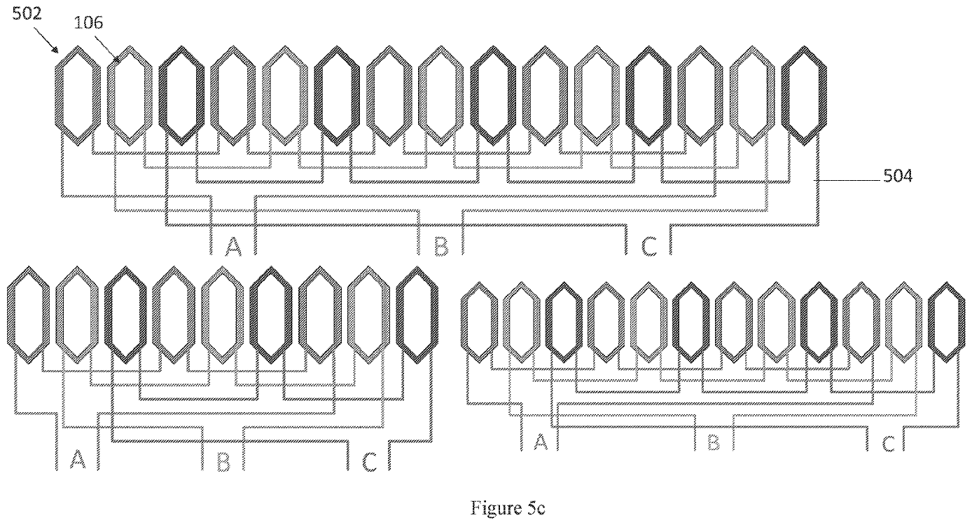

FIG. 5(a) illustrates an example motor topology with modular stator. In the example of FIG. 5(a) illustrating 15 stator modules, the stator has 15 field coils which are equal to the number of stator modules and 5 armature coils connected in series per phase. The field and armature windings connections are shown in FIG. 5 (b)-(c), respectively.

The general sizing equation for synchronous machines states that the output power is calculated as.

$${P}_{o u t} = η \frac{m}{T} {\int }_{0}^{T} e ( t ) i ( t ) dt \qquad ( 1 )$$

which can be written as

$${P}_{o u t} = η {mK}_{p} {E}_{B p k} {I}_{p k} = 1.5 η {E}_{p k} {I}_{p k} \qquad ( 2 )$$

Therein, E_{Bpk} and Iₚₖ, are the peak Back-EMF and peak armature current. The variables η, m and Kₚ are the efficiency and number of phase and power waveform factor respectively. A dual rotor 15-slot/20-pole FSM has negligible power from saliency.

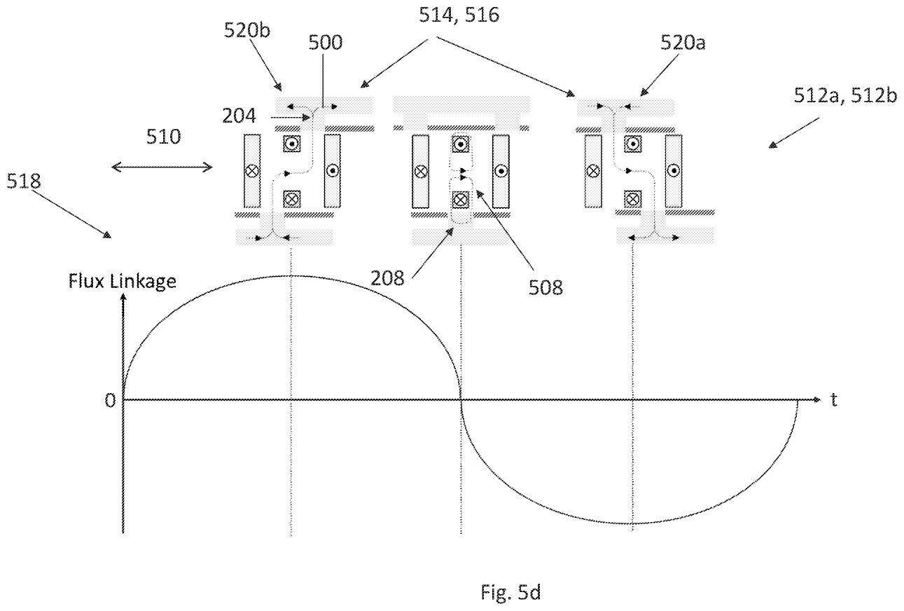

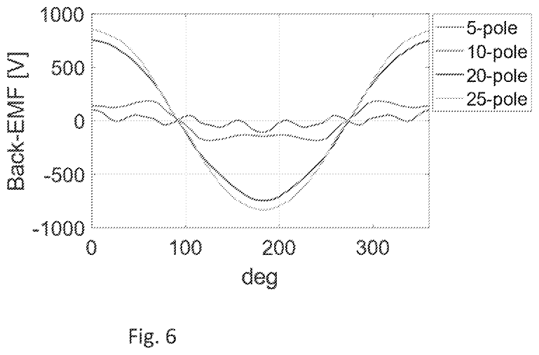

Feasible pole-slot combinations of a DRFSM with a superconducting shield can be obtained from the following equation [25].

$${N}_{pole} = {N}_{s l o t} ( 2 \pm \frac{n}{2 m} )$$

where m is the number of phases and n is any natural number. FIG. 6 shows the Back-EMF waveforms for the feasible pole numbers for the 15-slot machine. It is seen that the 5-pole and 10-pole machines have periodic back-emf, which are not sinusoidal, and the configurations with 20 poles and 25 poles have the sinusoidal back-emf. The 25-pole/15-slot machines have larger back-emf than the 20-pole/15-slot motor, but the difference is slight. The 25 pole/15-slot motor has a higher frequency than the 20-pole/15-slot motor, significantly decreasing efficiency. Therefore, to meet the power density and efficiency, the 20-pole/15-slot DRFSM with HTS coils and superconducting shield is selected.

Without being bound by a particular scientific theory, FIG. 5(d) illustrates an example working principle of the FSM, where a magnetic flux passes through the windings (when the HTS coils are excited) and switches its direction when the rotor rotates in a rotary FSM. The generated switching flux produces a bipolar AC flux linkage in the windings. Due to the rotors' salient structure, the variable reluctance path is offered to the flux, which switches when the rotor rotates.

e. Finite Element Analysis

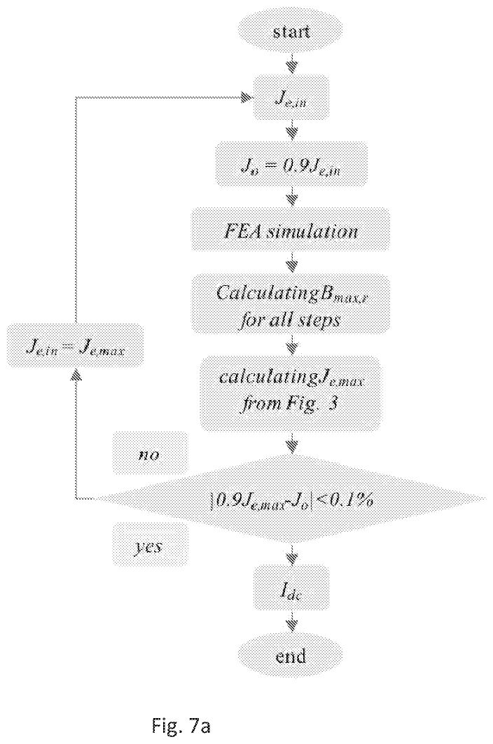

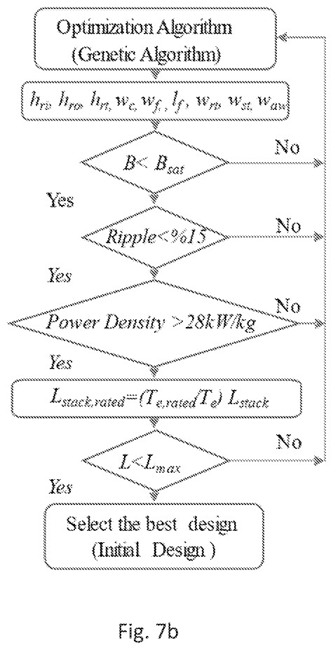

A Finite Element (FE) analysis (numerical analysis) was carried out using ANSYS Maxwell simulation tool, to develop an electromagnetic design of the double-rotor FSM. The calculation procedure for engineering current density is shown in FIG. 7a. First, the 2-D FEA model is built and solved with an initial input of J_{e, in} (e.g., in order to maintain the safety margin). In addition, the operating engineering current density of the machine is set to 90% of J_{e in} in order to maintain the safety margin. Maximum perpendicular B to the field coils are obtained, and the J_{e, max} is calculated based on FIG. 4c and maximum perpendicular B. J_{e max} is then compared with the initial input engineering current density. If the relative error between Jₑ₋ₘₐₓ and J_{e in} is >0.1%, J_{e in} is be adjusted and the iteration process is repeated. The final operating dc current I_{dc} can be identified when the relative error between maximum engineering current density and input engineering current density is smaller than or equal to 0.1%. Then Maxwell Ansys's built-in Genetic Algorithm (FIG. 7b) was used to optimize the geometry of the machine. According to Hiperco 50 B-H-curve, the flux density on the rotor should be smaller than Bₛₐₜ, the ripple should be limited by 15%, and the motor inductance should be smaller than Lₘₐₓ for 1 MW design.

The FE model is built using the physical dimensions for different pole/slot configurations as listed in the following tables.

TABLE IA
PHYSICAL DESIGN PARAMETERS OF A 20POLE/15SLOT
DOUBLE-ROTOR FSM; 250 KW AND 1 MW DESIGNS.

| | | 20pole/15slot | | 20pole/15slot | |
|---|---|---|---|---|---|
| Parameters | Symbol | (250 kW) | | (1 MW) | |
| The inner radius of the inner | rₛₕ | 75 | mm | 98 | mm |
| rotor | | | | | |
| The thickness of the inner | hᵣᵢ | 5 | mm | 8.5 | mm |
| rotor ring | | | | | |
| The thickness of the outer | hᵣₒ | 5 | mm | 6 | mm |
| rotor ring | | | | | |
| Rotor teeth height | hᵣₜ | 13 | mm | 13 | mm |
| Length of the field coil core | L_{core} | 15 | mm | 10 | mm |
| Airgap length | g | 1 | mm | 1 | mm |
| Field coil width | wₘ | 5.2 | deg | 5.2 | deg |
| Rotor tooth width | wᵣₜ | 5 | deg | 5 | deg |
| Stator tooth width | wₛₜ | 2.3 | deg | 2.3 | deg |
| The inner radius of the stator | rₛᵢ | 94 | mm | 120.5 | mm |
| The outer radius of the stator | rₛₒ | 113.5 | mm | 145 | mm |
| Stack length | L_{stack} | 30.1 | mm | 52.5 | mm |
| The outer radius of motor | rₒ | 132.5 | mm | 165 | mm |

| | | | |
|---|---|---|---|
| Number of turns per field coil | N_{fcoil} | 32 | 47 |
| Number of armatures winding | N_{winding} | 210 | 85 |
| turns for each phase | | | |

For the motor in Table IA, the double rotor structure made up of laminated HiperCo-50 has a mechanical airgap length of g=1 mm each with the stator. The stator comprising of ALW conductors and YBCO HTS coils possess RMS current densities of 60 A/mm² and 1956.9 A/mm² respectively. For the given motor geometry, the number of turns per each HTS coil for 250 kW and 1 MW design are N_{f coil}=32 and N_{fcoil}=47 respectively; while the number of ALW armatures winding turns for each phase for 250 kW and 1 MW design is N_{winding}=210 and N_{winding}=85 respectively. Under the given operating conditions, the stator currents, its frequency, and current densities are listed in Table IIA.

TABLE IB
INITIAL VALUES FOR 1 MW DRFSM-HTS 2O
POLE/15 SLOT GEOMETRY WITHOUT SHIELD.

| Parameters | Symbol | 20pole/15slot | |
|---|---|---|---|
| The inner radius of | rₛₕ | 99 | mm |
| the inner rotor | | | |
| The thickness of | hᵣᵢ | 7.2 | mm |
| the inner rotor ring | | | |
| The thickness of | hᵣₒ | 7.2 | mm |
| the outer rotor ring | | | |
| Rotor tooth height | hᵣₜ | 21 | mm |
| Field coil core | w_{c} | 8 | mm |
| width | | | |
| Field coil slot area | w_{f} | 6.8 | deg |
| width | | | |
| Field coil slot area | l_{f} | 2.5 | mm |
| length | | | |
| Rotor tooth width | wᵣₜ | 5.7 | deg |
| Stator tooth width | wₛₜ | 3.3 | deg |
| Stack length | L_{satck} | 167.4 | mm |

Table IB shows the motor geometry's initial values based on the optimization of FIG. 7b. The motor's power density, torque ripple, and inductance value are 28.5 kW/kg, 11%, and 70 uH, respectively.

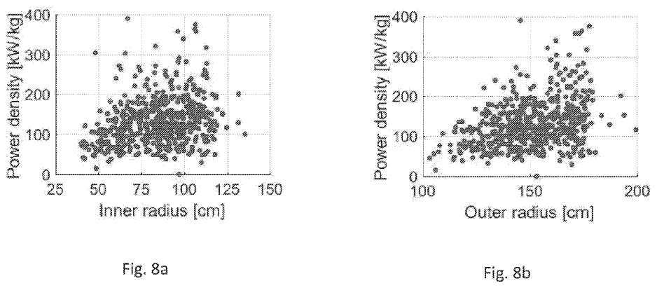

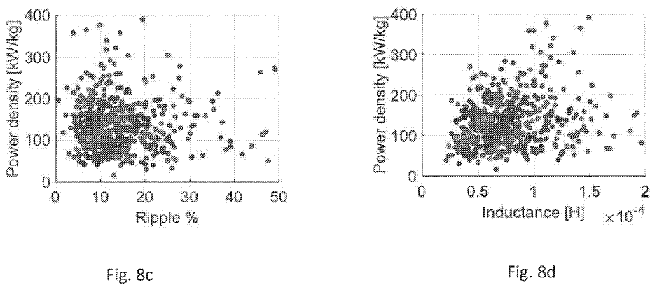

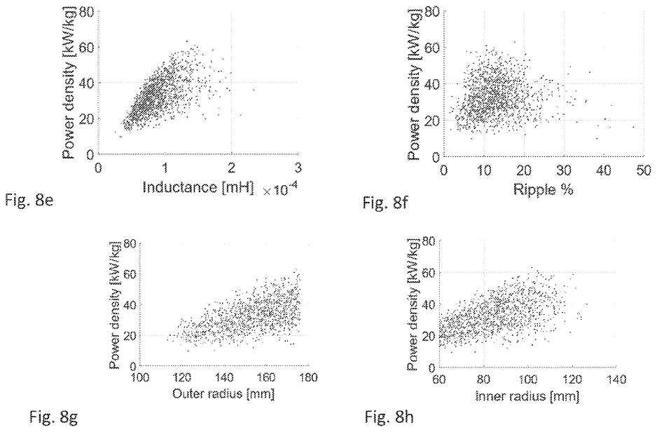

FIGS. 8 (d) and 8(e) show the power density versus inductance and torque ripple respectively. With increasing inductance, the power density increases; however, a high-voltage dc source is needed for driving a motor with large inductance. FIGS. 8 (e) and 8(f) show power density versus inner and outer radius of the motor; the power density increases with increasing the inner and outer radius. According to FIG. 8, the initial sizing of the motor is selected to have the highest power density while meeting other requirements. Then a parametric study is done to further optimize the design and obtain higher power density and lower torque ripple.

TABLE IC
INITIAL VALUES FOR PROPOSED 1 MW 20 POLE
15 SLOT DRFSM WITH SHIELD GEOMETRY

| Parameters | Symbol | 20pole/15slot | |
|---|---|---|---|
| The inner | rₛₕ | 101.26 | mm |
| radius of | | | |
| the inner | | | |
| rotor | | | |
| The | hᵣᵢ | 8.7 | mm |
| thickness | | | |
| of the | | | |
| inner rotor | | | |
| ring | | | |
| The | hᵣₒ | 7.3 | mm |
| thickness | | | |
| of the | | | |
| outer rotor | | | |
| ring | | | |
| Rotor | hᵣₜ | 11 | mm |
| tooth | | | |
| height | | | |
| Field coil | w_{c} | 10 | mm |
| core width | | | |
| Field coil | w_{f} | 6.6 | deg |
| slot area | | | |
| width | | | |
| Field coil | l_{f} | 1.12 | mm |
| slot area | | | |
| length | | | |
| Rotor | wᵣₜ | 5.6 | deg |
| tooth | | | |
| width | | | |
| Stator | wₛₜ | 2.8 | deg |
| tooth | | | |
| width | | | |
| Stack | L_{satck} | 59.6 | mm |
| length | | | |

FIGS. 8 (a) and (b) show the power density versus the inner and outer radius of the motor of Table IC. The power density increases with increasing the inner and outer radius of the motor. FIG. 8 (c) and (d) shows the power density versus torque ripple and armature winding inductance. According to FIG. 8 (d), the power density increases with increasing the inductance; however, there is a limit to inductance. According to FIG. 8, the initial sizing of the motor is selected to have the highest power density while meeting other requirements.

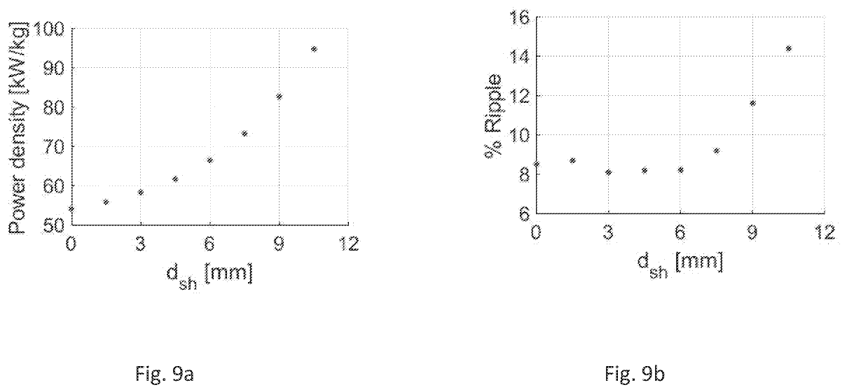

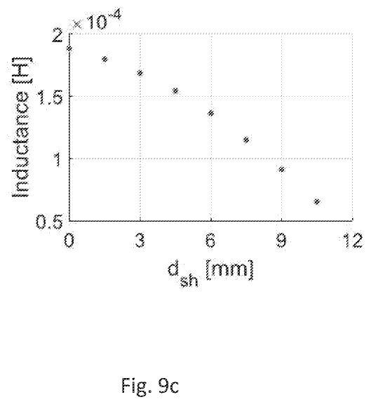

For simplicity, simulation of the superconducting shield is reproduced by setting a conductor of extremely high conductivity and very low permeability [6] and [7]. FIG. 9 shows the proposed motor's power density, ripple, and inductance changes versus the distance of the superconducting shield from the rotor's ring surface. In these figures, zero indicate that the shields are on the rotors' ring, and then the shields' distance increase by a step of 1.5 mm until the shield is at the same level as the rotor teeth.

According to FIG. 9, by increasing shield distance with rotor rings, the power density of the motor and torque ripple increase. Also, by increasing the distance of the shield from the rotor rings, the inductance decreases. By placing the superconducting shields at the same level as rotor teeth, maximum power density with minimum inductance is obtained; in this design, the torque ripple is less than 15%.

Table IC shows the motor geometry's initial values based on the optimization. motor's power density, torque ripple, and inductance value are 94.8 kW/kg, 14.4%, and 65.5 uH, respectively

Then a parametric study is done to further optimize the design and obtain higher power density and lower torque ripple.

f. Parametric Optimization

For further optimization, two sensitive parameters of motor geometry are grouped and varied in small steps, and their variation ranges and step size are listed in Table ID (no shield) and Table IE (with shield).

### (i) 20 Pole 15 Slot Machine, No Shield

After obtaining initial values for motor geometry, two sensitive parameters are grouped together and varied in small steps for further optimization. In this step, the inner radius and air gap are fixed on 99 mm and 0.5 mm, respectively. These design parameters and their ranges considered for optimization are listed in Table ID.

TABLE ID
USED PARAMETERS IN OPTIMIZATION.

| | | | Variation | | |
|---|---|---|---|---|---|
| Group | Parameters | Symbols | range | Step | |
| 1 | Stator | wₛₜ | 3.1 deg-3.5 deg | 0.05 | deg |
| | tooth | | | | |
| | width | | | | |
| | Rotor | wᵣₜ | 5.5 deg-5.8 deg | 0.05 | deg |
| | tooth | | | | |
| | width | | | | |
| 2 | field coil | w_{c} | 6 mm-10 mm | 1 | mm |
| | core width | | | | |
| | Rotor | hᵣₜ | 17 mm-23 mm | 1 | mm |
| | tooth | | | | |
| | height | | | | |
| 3 | Field coil | w_{f} | 6.3 deg-7 deg | 0.05 | deg |
| | slot area | | | | |
| | width | | | | |
| | Field coil | l_{f} | 2.3 mm-2.6 mm | 0.05 | mm |
| | slot area | | | | |
| | length | | | | |
| 4 | The | hᵣᵢ | 6.8 mm-7.4 mm | 0.1 | mm |
| | thickness | | | | |
| | of the | | | | |
| | inner | | | | |
| | rotor ring | | | | |
| | The | hᵣₒ | 6.8 mm-7.4 mm | 0.1 | mm |
| | thickness | | | | |
| | of the | | | | |
| | outer | | | | |
| | rotor ring | | | | |

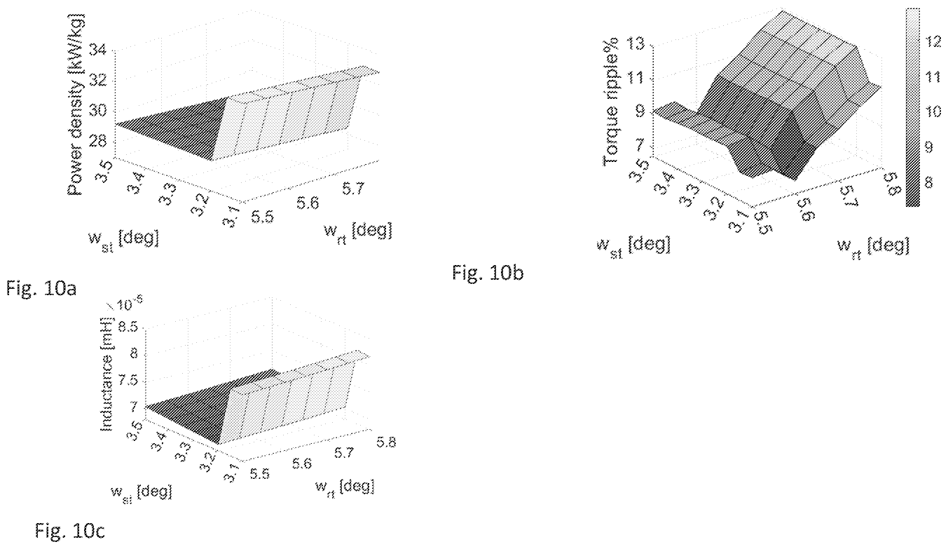

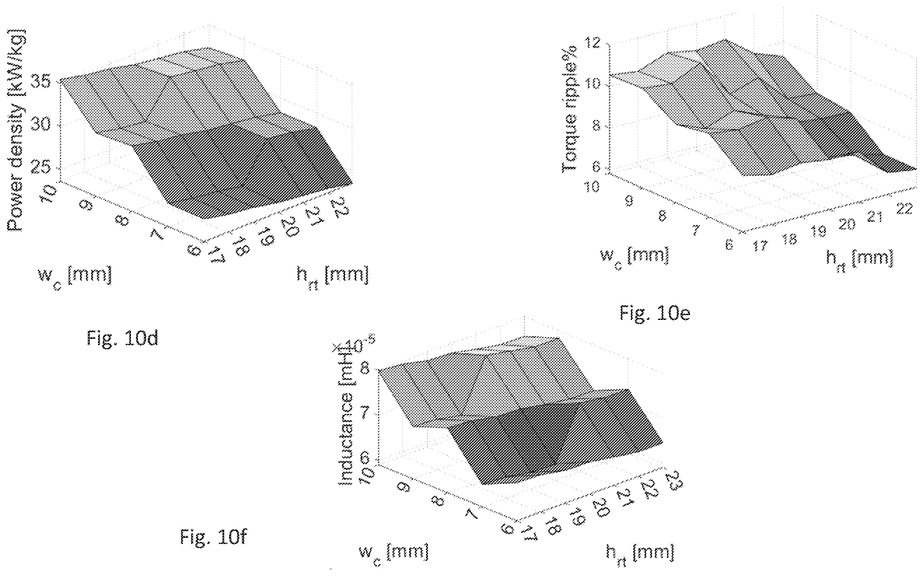

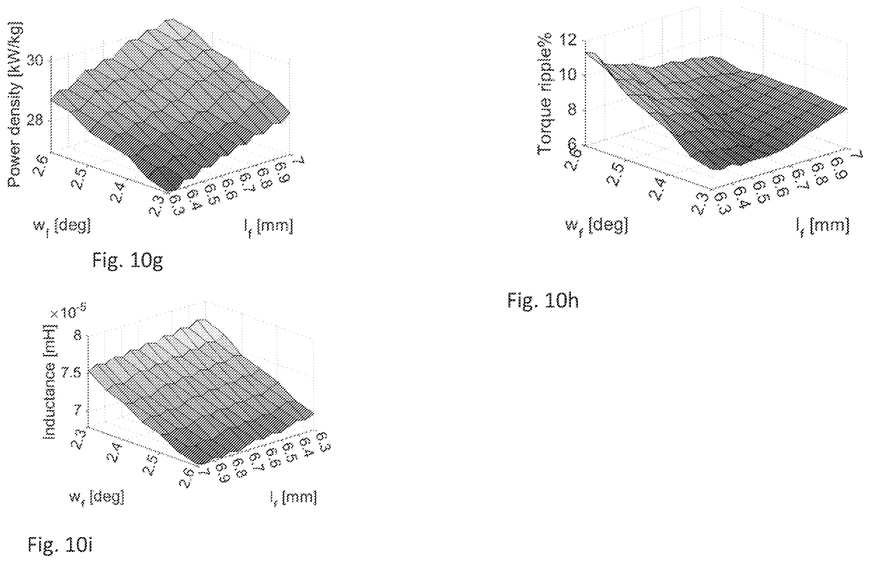

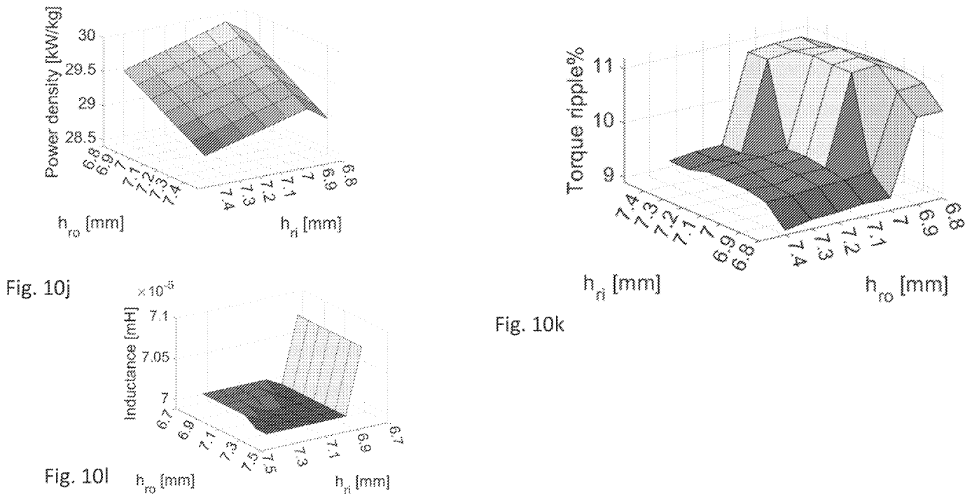

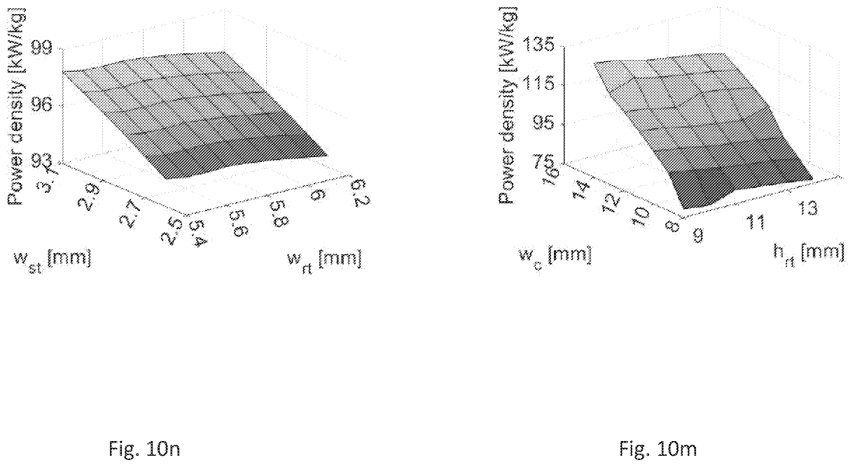

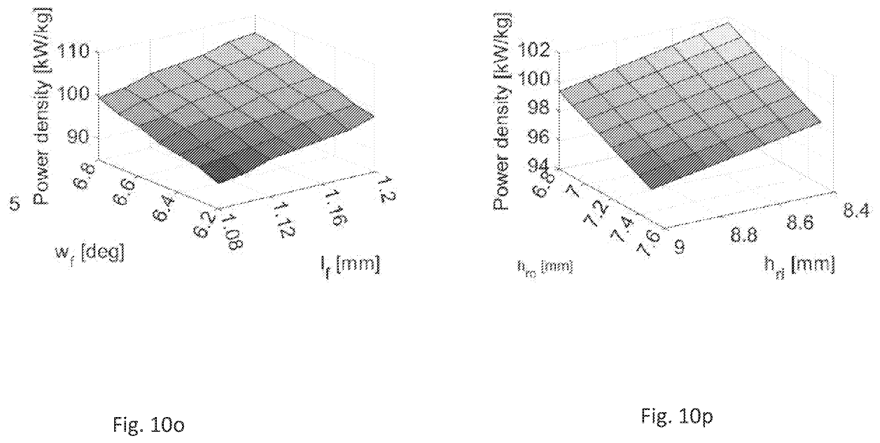

In the first step, the stator tooth width wₛₜ and rotor tooth width wᵣₜ are changed. By decreasing the wₛₜ, the slot area of armature winding increases, and the number of armature winding turns increases. The power density and inductance increase. The maximum power density is achieved at a stator tooth width of 3.1 deg, but the inductance is not in the acceptable range. The minimum torque ripple is achieved when wᵣₜ is 5.6 deg, which is 7%. The stator tooth and rotor tooth width are fixed at 3.5 deg and 5.6 deg to have maximum power density while maintaining the flux density on the rotors, inductance, and torque ripple in the acceptable range. The power density versus wₛₜ and wᵣₜ is shown in FIG. 10 (a).

The next step changes the field coil's core width w_{c} and rotor tooth height hᵣₜ. Increasing the field coil's core width and rotor tooth height increases power density and inductance, see FIGS. 10d-f By increasing the w_{c}, the torque ripple increases. By increasing the hᵣₜ the torque ripple decreases. Based on the limitation for flux density, torque ripple, and inductance, the core width and rotor tooth height are fixed at 8 mm and 21 mm, respectively.

The third step changes the field coil slot area width w_{f} and field coil slot area length l_{f}. By changing these parameters, the field coil's slot area and, subsequently, the number of field coil turns changes. FIG. 10 (g) shows the power density versus field coil slot width and length. According to FIG. 10g-i, the power density increases by increasing these parameters, and also the flux density increase. By increasing these parameters, the inductance increases. To meet the required range for torque ripple and inductance and have maximum power density, the width and length of the field coil's slot are fixed at 6.55 deg and 2.55 mm, respectively.

In the final step, the thickness of the inner hᵣᵢ and outer rotor hᵣₒ is changed to have maximum power density and keep the flux density on the rotors, inductance, and torque ripple in the acceptable range. According to FIG. 10 (j), the power density increases with decreasing thickness of rotor rings, but the flux density on the rotor also increases. With decreasing the inner ring thickness the torque ripple and inductance increase respectively. hᵣᵢ should be 7 mm, and hᵣₒ should be 7.1 mm to have maximum power density and smaller torque ripple while flux density on the rotors and inductance is in the accepted range. The physical dimensions of the optimized 20-pole/15-slot can be referred from Table IE.

TABLE IE
PHYSICAL DESIGN PARAMETERS OF
A 20-POLE/15-SLOT DRFSM-HTS.

| Parameters | Symbol | 20pole/15slot | |
|---|---|---|---|
| The inner radius | rₛₕ | 99 | mm |
| of the inner rotor | | | |
| The thickness of | hᵣᵢ | 7 | mm |
| the inner rotor | | | |
| ring | | | |
| The thickness of | hᵣₒ | 7.1 | mm |
| the outer rotor | | | |
| ring | | | |
| Rotor tooth height | hᵣₜ | 21 | mm |
| Field coil core | w_{c} | 8 | mm |
| width | | | |
| Airgap length | g | 0.5 | mm |
| Field coil slot are | w_{f} | 6.55 | deg |
| width | | | |
| Field coil slot are | l_{f} | 2.55 | mm |
| length | | | |
| Rotor tooth width | wᵣₜ | 5.6 | deg |
| Stator tooth width | wₛₜ | 3.5 | deg |
| Stack length | L_{satck} | 168.2 | mm |
| (250 kW) | | | |
| The outer radius | rₒ | 169.2 | mm |
| of motor | | | |

(ii) 20 Pole 15 Slot Machine with Shield

TABLE IE
PARAMETERS IN PARAMETRIC OPTIMIZATION

| | | | Variation | | |
|---|---|---|---|---|---|
| Group | Parameters | Symbols | range | Step | |
| 1 | Stator | wₛₜ | 2.6 deg-3.1 deg | 0.1 | deg |
| | tooth | | | | |
| | width | | | | |
| | Rotor | wᵣₜ | 5.4 deg-6.2 deg | 0.1 | deg |
| | tooth | | | | |
| | width | | | | |
| 2 | Field coil | w_{c} | 8 mm-14 mm | 1 | mm |
| | core width | | | | |
| | Rotor | hᵣₜ | 9 mm-14 mm | 1 | mm |
| | tooth | | | | |
| | height | | | | |
| 3 | Field coil | w_{f} | 6.2 deg-6.8 deg | 0.1 | deg |
| | slot area | | | | |
| | width | | | | |
| | Field coil | l_{f} | 1.08 mm-1.2 mm | 0.02 | mm |
| | slot area | | | | |
| | length | | | | |
| 4 | Thickness | hᵣᵢ | 8.4 mm-9 mm | 0.1 | mm |
| | of the | | | | |
| | inner rotor | | | | |
| | ring | | | | |
| | Thickness | hᵣₒ | 6.8 mm-7.5 mm | 0.1 | mm |
| | of the | | | | |
| | outer rotor | | | | |
| | ring | | | | |

The inner radius and air gap are fixed at 101.26 mm and 1 mm, respectively and a similar optimization procedure to that in (i) is followed.

FIGS. 10n-p show the power density versus the variation of two grouped parameters. In each step value of parameters is fixed to have maximum power density with inductance, ripple, and flux density on the rotors in their limitation. Table IF shows the optimized values of motor geometry. The power density of the 20-pole/15-slot proposed motor is 100.5 kW/kg, the torque ripple is 9.35%, and the inductance of the motor is 64 mH.

TABLE IF
INITIAL VALUES FOR PROPOSED 1
MW DRFSM WITH SHIELD GEOMETRY

| Parameters | Symbol | 20pole/15slot | |
|---|---|---|---|
| The inner | rₛₕ | 101.26 | mm |
| radius of | | | |
| the inner | | | |
| rotor | | | |
| The | hᵣᵢ | 8.5 | mm |
| thickness | | | |
| of the | | | |
| inner rotor | | | |
| ring | | | |
| The | hᵣₒ | 7 | mm |
| thickness | | | |
| of the | | | |
| outer rotor | | | |
| ring | | | |
| Rotor | hᵣₜ | 11 | mm |
| tooth | | | |
| height | | | |
| Field coil | w_{c} | 10 | mm |
| core width | | | |
| Airgap | g | 1 | mm |
| length | | | |
| Field coil | w_{f} | 6.6 | deg |
| slot are | | | |
| width | | | |
| Field coil | l_{f} | 1.12 | mm |
| slot are | | | |
| length | | | |
| Rotor | wᵣₜ | 5.6 | deg |
| tooth | | | |
| width | | | |
| Stator | wₛₜ | 2.8 | deg |
| tooth | | | |
| width | | | |
| Stack | L_{satck} | 60.1 | mm |
| length | | | |

g. Numerical Simulation
(i). 20 pole/15 slot using parameters of Table IA

TABLE II
CURRENT DENSITIES OF ARMATURE AND FIELD COILS.

| Motor Design | 20pole/15slot | 20pole/15slot |
|---|---|---|
| (Pole-Slot configurations | (250 kW) | (1 MW) |
| YBCO Current density (A/mm²) | 1956.9 | 1956.9 |
| ALW current density (A/mm²) | 60 | 60 |
| Armature Current (RMS) (A) | 159.8 | 639.2 |
| Field Current (A) | 1030 | 1030 |
| Armature Current Frequency (Hz) | 1666.66 | 1666.66 |

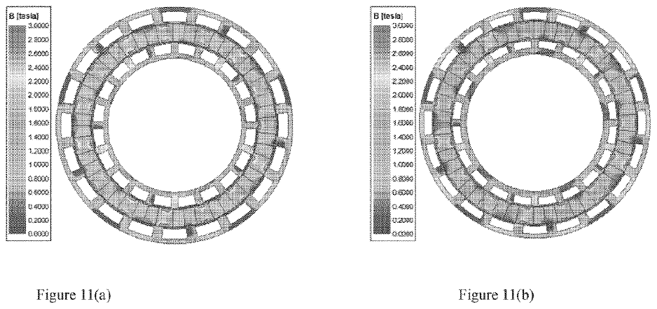

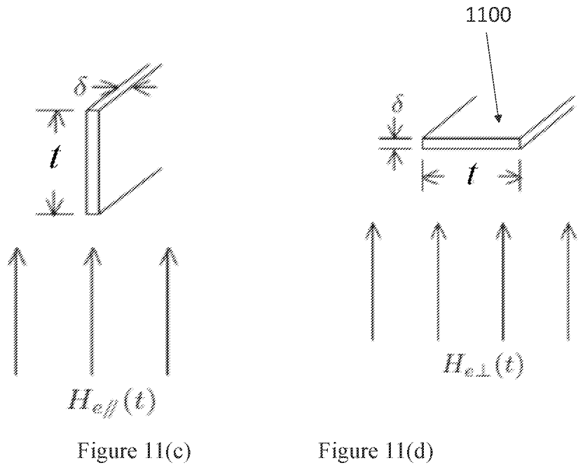

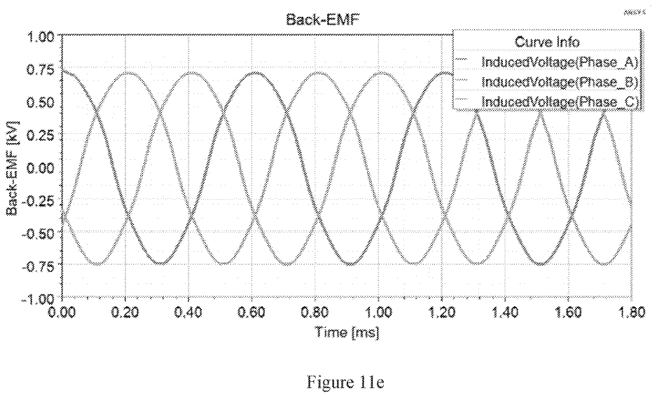

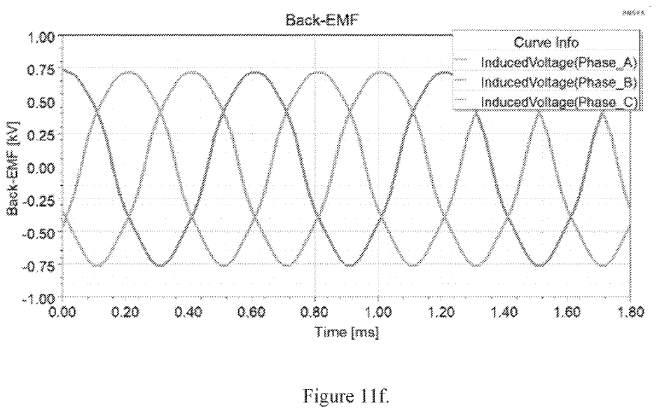

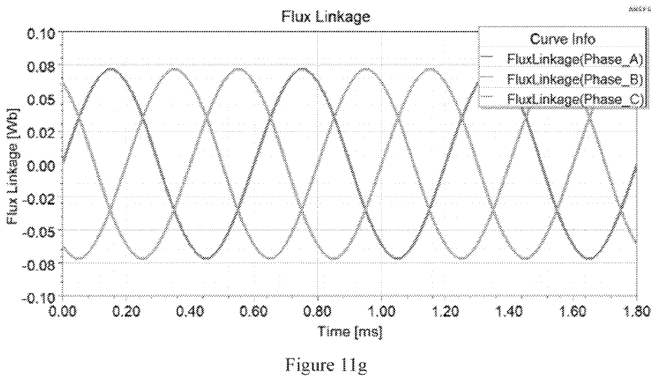

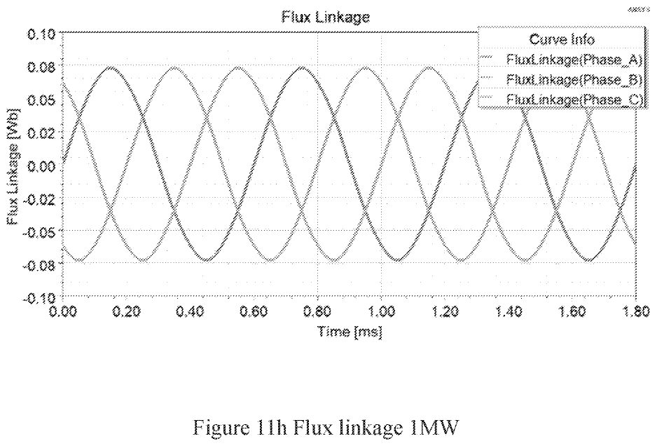

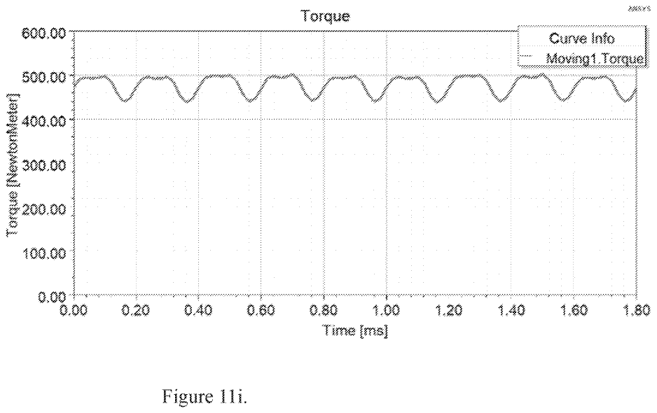

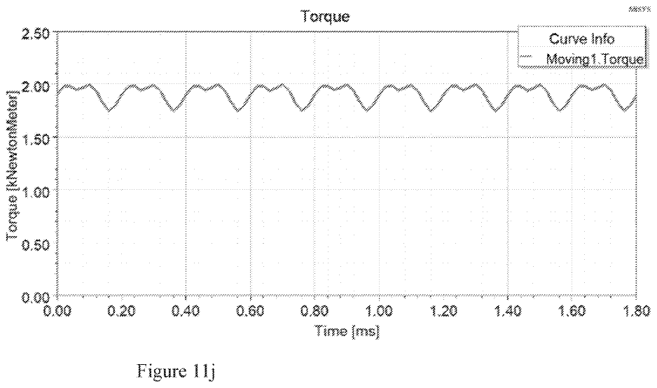

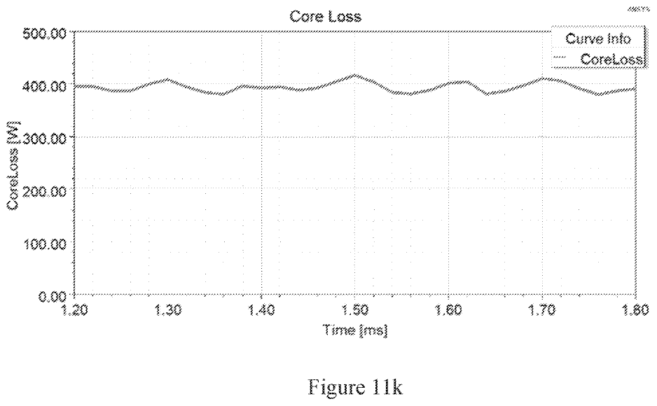

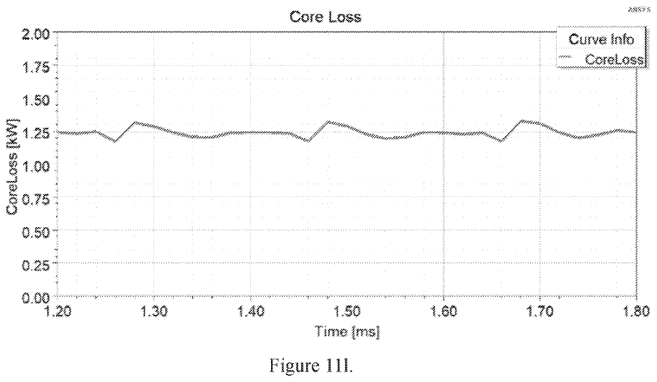

FIG. 11a shows the developed FE model of an FSM motor, illustrating the flux density distribution of the machine when operated under rated operational speed.

In general, the flux per phase winding for flux switching machine is given as [26]

$$λ ( t ) = {N}_{t , winding} {B}_{g , max} {K}_{m} {K}_{t} ( \frac{{D}_{i s} π}{{N}_{s t a t o r}} ) {L}_{stack} cos ( {N}_{p o l e} {ω}_{m} t ) \qquad ( 3 )$$

where N_{t,windning} is the number of armatures winding turns connected in series per phase, B_{g,max} is the maximum airgap flux density in between the aligned stator tooth and rotor tooth, Kₘ is the ratio of flux linkage over the total flux (linkage flux and leakage flux), Kₜ is the stator tooth width ratio; it is the ratio of stator tooth width over stator pole pitch width. Dᵢₛ is the stator inner diameter, Nₛₜₐₜₒᵣ is the number of stator slots, L_{stack} is the effective length for motor, Nₚₒₗₑ is the number of rotor poles and ωₘ is the mechanic speed of rotor.

The motor Back-EMF is calculated as (4),

$${E}_{B} ( t ) = 2 {π}^{2} {N}_{t , winding} {B}_{g , max} {K}_{m} {K}_{t} ( \frac{{N}_{pole} {f}_{m}}{{N}_{stator}} ) \times {D}_{is} {L}_{stack} sin ( {N}_{pole} {ω}_{m} t ) \qquad ( 4 )$$

where fₘ is the mechanical frequency. The output power of a machine can be calculated from (3).

$$\begin{matrix}{P}_{out} = η \frac{m}{T} {\int }_{0}^{T} e ( t ) i ( t ) dt = η {mK}_{p} {E}_{B max} {I}_{max} \\ = 1.5 η {E}_{B max} {I}_{max} \\ = 3 η {π}^{2} {N}_{t , winding} {B}_{g , max} {K}_{m} {K}_{t} ( \frac{{N}_{pole} {f}_{m}}{{N}_{stator}} ) \times \\ {D}_{is} {L}_{stack} sin ( {N}_{pole} {ω}_{m} t ) {I}_{max}\end{matrix} \qquad ( 5 )$$

where E_{Bmax} and Iₘₐₓ are the maximum value of Back-EMF and armature current. η, m and Kₚ are the efficiency, number of phases and electrical power waveform factor. The proposed dual rotor FSMs is 3-phase and therefore has negligible saliency and negligible reluctance torque. As a result, it is assumed that all torque is produced by magnet torque. Equation (5) shows that with the increase in the ratio of linkage flux over the summation of linkage flux and leakage flux (Kₘ), the output power increases. Therefore, placing superconducting shield between rotor teeth leads to a decrease in the leakage flux and an increase in the linkage flux, which would eventually increase the output power and power density while keeping the physical geometry unchanged.

For an example transient analysis, the double-rotor FSM can be operated at a mechanical speed of N=5000 RPM with a given field excitation current of I_{dc} 1030 A. The sinusoidal armature current of I_{ALW}=159.8 A is fed as the input rms current to 250 kW motor and the sinusoidal armature current of I_{ALW}=639.2 A is fed as the input rms current to 1 MW motor. Under the given operating conditions, the characteristic performance of the machine is obtained in terms of electromagnetic quantities, like motor back-EMF, flux linkage and torque, and is given in FIGS. 11e-j respectively. The desired motor back-EMF at the rated operational speed is found to be E_{B}=523.2 V and E_{B}=528.9 V for 250 kW and 1 MW design respectively. The maximum flux linkage of ψ=0.72 Wb is observed at the rated field excitation conditions for both 250 kW and 1 MW design. The maximum output torque obtained at the rated conditions is T_{E}=477.5 N·m and T_{E}=1909 N·m.

With the given current densities, and number of windings turns in each slot, the overall weight of the stator inclusive of armature and field windings was evaluated, as given in Table III.

TABLE III
TOTAL WEIGHT OF THE MOTOR.

| Motor Design (Polea.-Slot | 20pole/15slot | 20pole/15slot |
|---|---|---|
| configurations) | (250 kW) | (1 MW) |
| Rotor weight (kg) | 2.74 | 7.5 |
| Field winding weight (kg) | 0.17 | 0.35 |
| Armature winding weight (kg) | 0.55 | 1.35 |
| Total Weight of the Motor (kg) | 3.8 | 9.8 |
| YBCO Length (m) | 51.5 | 105.5 |
| Al Litz wire Length (m) | 76.5 | 47 |

The motor design delivers maximum output power and torque. With reference to the effective motor weight of 3.8 kg and 9.8 kg for 250 kW and 1 MW design, the maximum power density delivered by the newly designed motor is 67 kW/kg and 102 kW/kg respectively.

Losses were calculated to evaluate the efficiency of the motor. The evaluated losses comprise of core losses (P_{c}), ALW loss (P_{At}) and YBCO loss (P_{YBCO}) and superconducting shielding loss (P_{shield}), carried at frequency, f=1667 Hz. The losses for ALW at temperature, T=95 K and YBCO HTS at T=65 K, was evaluated based on computational analysis referred in [11]. The total losses (P_{T}) in the machine can be given from (6).

$${P}_{T} = {P}_{c} + {P}_{Al} + {P}_{YBCO} + {P}_{shield} \qquad ( 6 )$$

The core losses P_{c} for both 250 kW and 1 MW design are computed from the FE analysis and is given in FIG. 11k-l.

The ALW losses which comprise of ohmic resistive loss Pᵣ and eddy current loss P, are computed from the following equations given in (7-8).

$${P}_{r} = ρ \frac{l}{A} {I}^{2} [ W ] \qquad ( 7 )$$

$${P}_{e Al} = \frac{{π}^{2}}{k ρ} {( {fB}_{m} d )}^{2} [ W / {m}^{3} ] \qquad ( 8 )$$

Where ρ, l, A and I are the resistivity, length, area of cross-section of ALW and rms value of armature current respectively. f is the frequency of the time dependence of the applied field. Bₘ is the maximum applied field amplitude (½ the peak-to-peak variation), and d is a diameter of the whole strand or the width of the tape perpendicular to the applied field.

The YBCO losses comprise eddy current loss (P_{e,YBCO}) and Hysteresis loss (Pₕ) They are evaluated using the following equations given in (9-10).

$${P}_{e , YBCO} = \frac{{π}^{2}}{k ρ} {( {fB}_{m} d )}^{2} [ W / {m}^{3} ] \qquad ( 9 )$$

$${P}_{h} = {vB}_{m} {J}_{e} {d}_{f} f [ W / {m}^{3} ] \qquad ( 10 )$$

where ρ is the resistivity of YBCO coated conductor stabilizer and substrate, k is 6 for a flat coated conductor tape, lₑ is current density based on whole conductor area, d_{f} is the diameter of the whole strand or the width of the tape perpendicular to the applied field, and v=1 for a tape.

The superconducting shielding losses comprise of hysteresis loss P_{sh,hy} and eddy current loss (P_{zh,ed}).[12]. FIG. 11d-e shows the superconductor is exposed to a time-varying magnetic field (Hₑ(t)) can be decomposed to two orthogonal vectors, H_{e∥}(t) and H_{e⊥}(t).

The losses P_{zh,hy} are from parallel and perpendicular magnetic field and is calculated from (11-17).

$${e}_{hy \vert \vert} = \frac{2}{3} \frac{{μ}_{e} {H}_{m \vert \vert}^{2}}{{H}_{p \vert \vert}} [ J / {m}^{3} ] \qquad ( 11 )$$

$${H}_{p \vert \vert} = {J}_{e} \frac{δ}{2} [ A / m ] \qquad ( 12 )$$

$${P}_{hy \vert \vert} = {e}_{hy \vert \vert} \cdot f \cdot V [ W ] \qquad ( 13 )$$

$${e}_{hy ⊥} ≅ \frac{1}{6} {μ}_{0} {{H}_{m ⊥}^{2} ( \frac{{H}_{m ⊥}}{{H}_{p}} )}^{2} ( \frac{t}{δ} ) [ J / {m}^{3} ] \qquad ( 14 )$$

$${H}_{p ⊥} = {J}_{e} \frac{t}{2} [ A / m ] \qquad ( 15 )$$

$${P}_{hy ⊥} = {e}_{hy ⊥} \cdot f \cdot V [ W ] \qquad ( 16 )$$

$${P}_{sh , hy} = {P}_{hy \vert \vert} + {P}_{hy ⊥} \qquad ( 17 )$$

where H_{m∥}, V and lₑ are maximum magnitude of parallel magnetic field, frequency, volume of superconducting shielding and current density and e_{hy∥} and P_{hy∥} are hysteresis energy density and hysteresis loss from parallel magnetic field respectively. The field H_{m⊥}, is maximum magnitude of perpendicular magnetic field, e_{hy⊥} is hysteresis energy density, and P_{hy⊥} is hysteresis loss from perpendicular magnetic field respectively. The losses are shown in Table IV.

TABLE IV
LOSSES OF 250 KW AND 1 MW DESIGN.

| | 20pole/15slot | 20pole/15slot |
|---|---|---|
| | With- | (With- |
| | shield- | shield- |
| Design | 250 kW) | 1 MW) |
| P_{AI, loss} (W) | 3254.4 | 7997 |
| P_{YBCO, loss} | 1107.5 | 2273.3 |
| (w) | | |
| P_{C} (W) | 400 | 1248 |
| P_{shield} (W) | 500 | 2000 |
| Total loss | 5262 | 13519 |
| (W) | | |
| Output | 251.9 | 999.5 |
| power | | |
| (kW) | | |
| Efficiency | 97.9 | 98.6 |

With the given losses, the motor under efficiency is found to be 97.9% and 98.6% for 250 kW and 1 MW, respectively. The overall performance of the motor is given subsequently in Table V.

TABLE V
MOTOR PERFORMANCE OF 250 KW AND 1 MW DESIGN.

| | 20pole/15slot | 20pole/15slot |
|---|---|---|
| | (With-shield- | (With-shield- |
| Design | 250 kW) | 1 MW) |
| Back-EMF (RMS) (V) (take-off and | 523.2 | 528.9 |
| cruise) | | |
| Average Torque (N · m) (take-off) | 477.5 | 1909 |
| Output power (kW) | 1666.66 | 1666.66 |
| Efficiency (take-off) | 97.9% | 98.6% |
| Power density (kW/kg) | 67 | 102 |

To show the effectiveness of using superconductive shielding in Table VI, the FSM at 250 kW and 1 MW are compared with the 250 kW and 1 MW FSM with and without superconductive shielding. In order for this comparison to be fair, the dimensions of two FSMs with and without superconducting shielding are the same.

TABLE VI
POWER DENSITY COMPARISON OF 250 KW AND 1 MW DESIGN
WITH AND WITHOUT SUPERCONDUCTING SHIELD.

| | 20pole/15slot | 20pole/15slot | 20pole/15slot | 20pole/15slot |
|---|---|---|---|---|
| | (With- | (With- | (Without- | (Without- |
| | shield- | shield- | shield- | shield- |
| Designs | 250 kW) | 1 MW) | 250 kW) | 1 MW) |
| Power | 67 | 102 | 31.8 | 45.25 |
| density | | | | |
| (kW/kg) | | | | |

Placement of the shield on the rotor at interpole locations reduces flux leakage and increases the magnetizing flux and power density and as shown in Table-6, and leads to an increase of the power density by about 2x.

### (ii). 20 Pole 15 Slot No Shield (Table IE)

The FE model is built using the physical dimensions in Table IE. The number of turns per each HTS coil is N_{f,coil}=71, and the number of turns per each armature coil is N_{A,coil}=6. Under the given operating conditions, the engineering current density of YBCO and the current density of ALW are 1915 A/mm² and 60 A/mm², respectively. In this design, the 0.8 safety factor for engineering current density is considered.

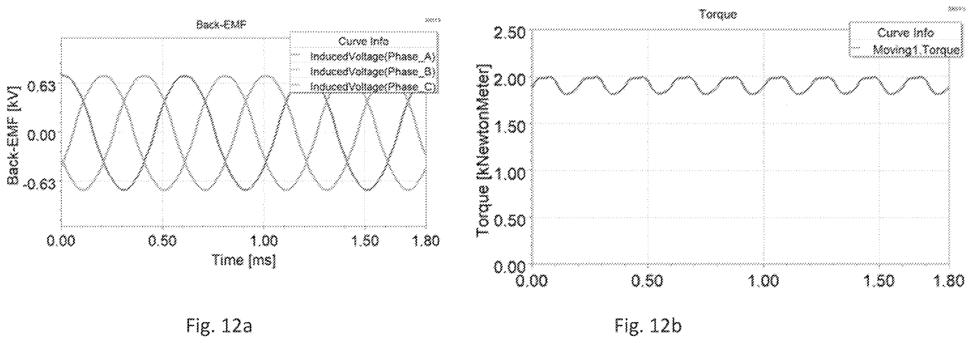

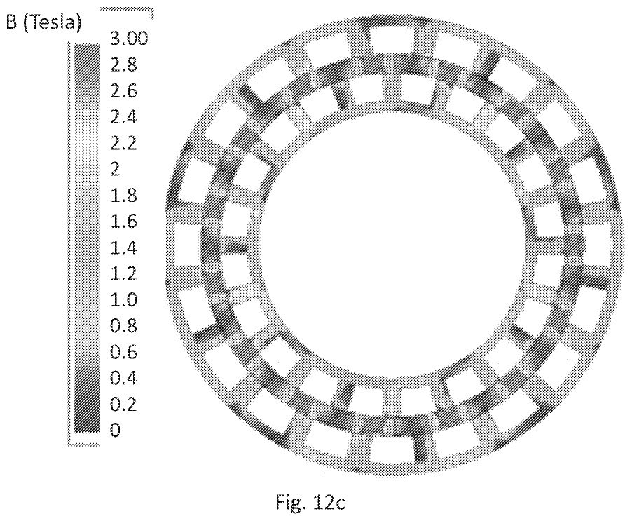

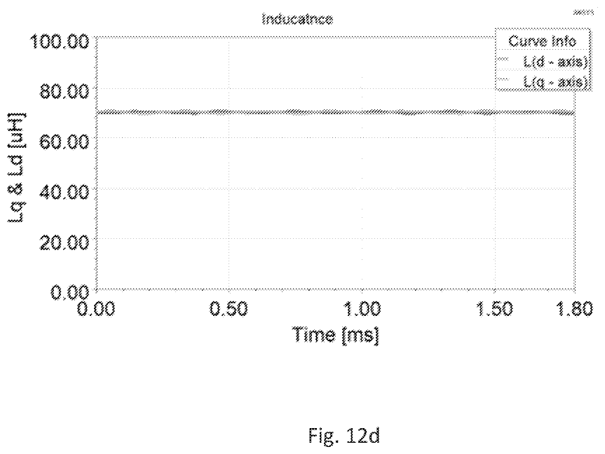

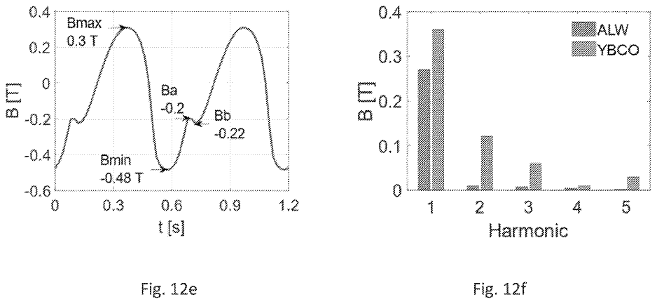

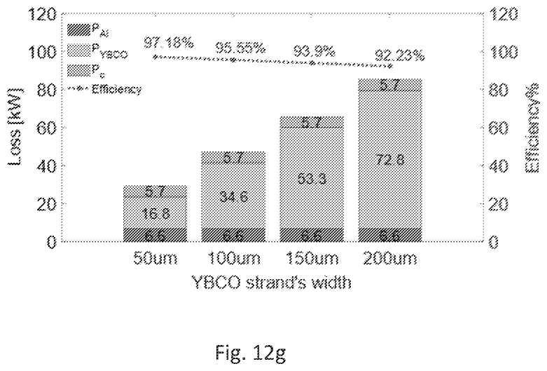

The DRFSM-HTS is operated at a mechanical speed of 5000 RPM with a given field excitation current of I_{dc}=1011 A. The sinusoidal armature current of I_{ALW}=640 A is fed as the input rms current to the motor. With the given input conditions, it can be confirmed that an output power of 1 MW is secured at rated operating conditions. Under the given operating conditions, the back-emf and torque are shown in FIGS. 12a-12b. The RMS value of back-emf at the rated operational speed is found to be E_{B}=523.25 V. The maximum output torque obtained at the rated condition is Tₑ=1910.5 N·m. and torque ripple is 9.7%.

FIG. 12c shows DRFSM-HTS flux density when operating under rated conditions. FIG. 12d shows the inductances in d and q axis for the motor. The average value of L_{d} and L_{q} for the proposed motor is 70.13 uH and 70.16 uH, respectively. This confirms that the inductance of the proposed motor is in the acceptable range. It is also seen that there is negligible saliency in the designed motor.

The magnetic field distribution in the middle of the slot of the field coil and armature winding is considered for the loss calculation [27]. Because the end winding of armature winding and field coils are not experiencing a variable magnetic field, they are not considered in loss calculations [27]. The magnetic field on the YBCO and harmonic spectrum of the magnetic field on field coil are shown in FIGS. 12e and 12f.

The loss components for the motor include core losses P_{c}, ALW loss P_{Al} and YBCO loss P_{YBCO}. The total losses P_{T} in the machine can be found from (2) and efficiency is calculated from (19).

$${P}_{T} = {P}_{Al} + {P}_{YBCO} + {P}_{C} \qquad ( 18 )$$

$$η = \frac{{P}_{out}}{{P}_{out} + {P}_{loss}} \qquad ( 19 )$$

The core losses P_{c} for proposed motor is computed from the FE analysis. The ALW losses which comprise of resistive Loss (P_{r,AL}) and eddy current loss (P_{e,AL}) are computed from the following equations given in (20)-(21)

$${P}_{r , Al} = ρ \frac{{l}_{Al}}{A} {I}^{2} [ W ] \qquad ( 20 )$$

$${P}_{e , Al} = {\sum }_{i = 1}^{5} \frac{{π}^{3}}{32 ρ} {( {f}_{i} {B}_{m , i} )}^{2} {d}^{4} nl [ W ] \qquad ( 21 )$$

where ρ, A, l_{Al}, and I are the resistivity, area of cross-section, length of ALW, and RMS value of armature current. fᵢ is the frequency of the corresponding harmonic of the applied field, B_{m,i} is the amplitude of corresponding harmonics of the applied field, d is the diameter of the strand and n is the number of filaments. The YBCO losses comprising of eddy current loss P_{e,YBCO} and hysteresis loss P_{h,YBCO}. The P_{e,YBCO} calculated based on analysis in [28] using following equation.

$${P}_{e , YBCO} = {\sum }_{i = 1}^{5} \frac{{π}^{2}}{k {ρ}_{n}} {( {fB}_{m , i} {d}_{f} )}^{2} {wtl}_{YBCO} [ W ] \qquad ( 22 )$$

In equation (22) p, and t is the resistivity and thickness of the corresponding layer. l_{YBCO} and w is length and width of tape. k is 6 for flat tape, d_{f} is the width of superconductor filament. The hysteresis loss of YBCO considering harmonics is calculated based on [29] and [30] using equation(7)

$${P}_{h , YBCO} = 4 n {{μ}_{0} ( \frac{{d}_{f}}{2} )}^{2} {fJ}_{c} {H}_{f} ( Δ h ) g ( Δ h ) [ W / m ] \qquad ( 23 )$$

where

$$Δ h = \frac{{H}_{max} - {H}_{min}}{2 {H}_{f}} ,$$

H_{f}=J_{c}/π, J_{c}=j_{c}d_{YBCO}, j_{c} and d_{YBCO} are critical current density and thickness of YBCO layer in the tape and

$$g ( x ) = \frac{2}{x} ln cosh ( x ) - tanh ( x ) .$$

In [30], it is shown that because the magnetic field is shielded by the turns above and below in racetrack coil, its AC loss is 10 to 20 times smaller than single tape loss. Therefore, calculated AC losses from (22) and (23) will be decreased because of shielding effect of stacked coil.

In one embodiment, the active part weight of the motor is about 34 kg, and the power density of the proposed motor is approximately 30 kW/kg, and for the armature winding made of ALW and YBCO field coils are operating at 95K and 65K the designed motor has high-power density of approximately 30 kW/kg and can reach an efficiency of 97%.

Table VII shows the losses and efficiency of proposed motor with different YBCO filament width with considering reduction factor of shielding effect of YBCO.

TABLE VII
THE LOSSES OF DIFFERENT PARTS OF MOTOR WITH
DIFFERENT WIDTH OF FILAMENT OF YBCO

YBCO filament width

| | 50 um | 100 um | 150 um | 200 um |
|---|---|---|---|---|
| P_{e, YBCO} [kW] | 0.04 | 0.15 | 0.35 | 0.6 |
| P_{h, YBCO} [kW] | _{≤1} | _{≤2} | _{≤3.2} | _{≤4.2} |
| P_{r, Al} [kW] | 5.8 | 5.8 | 5.8 | 5.8 |
| P_{e, AL} [kW] | 0.06 | 0.06 | 0.06 | 0.06 |
| P_{YBCO=} P_{e, YBCO+} | _{≤1.04} | _{≤2.15} | _{≤3.55} | _{≤4.8} |
| P_{h, YBCO} [kW] | | | | |
| P_{ALW=} P_{r, Al+} | 5.86 | 5.86 | 5.86 | 5.86 |
| P_{e, AL} [kW] | | | | |
| P_{c} [kW] | 5.7 | 5.7 | 5.7 | 5.7 |

In another embodiment, the rotor weight, armature winding weight and field coils weight are 31.2 kg, 1.1 kg and 1.9 kg, respectively. The support structure and TMS weigh is approximately 24.67 kg. The active power weight of motor including rotor, armature winding, and field coils are 34.2 kg and output power of the motor is 1000 kW. The active parts power density is 29.3 kW/kg and power density of motor considering Support system, mechanical and TMS is about 18.5 kw/kg and can reach efficiency greater than or equal to 98.7%. Table VIII shows the final parameters for the motor.

TABLE VIII
FINAL PARAMETERS OF THE MOTOR

| | YBCO filament width | | | |
|---|---|---|---|---|
| | 50 um | 100 um | 150 um | 200 um |
| Output power | 1000 | 1000 | 1000 | 1000 |
| [kW] | | | | |
| Armature | 640 | 640 | 640 | 640 |
| windings | | | | |
| current [A] | | | | |
| DC coils | 1011 | 1011 | 1011 | 1011 |
| current [A] | | | | |
| Power factor | 0.75 | 0.75 | 0.75 | 0.75 |
| Losses [kW] | _{≤12.6} | _{≤13.71} | _{≤15.11} | _{≤16.36} |
| Efficiency | _{≥98.7%} | _{≥98.6%} | _{≥98.5%} | _{≥98.4%} |
| Active power | 29.3 | 29.3 | 29.3 | 29.3 |
| density | | | | |
| [kW/kg] | | | | |

(iii) 20 Pole 15 Slot DRFSM with Superconducting Shield and Hts Coils Using Parameters of Table 1F

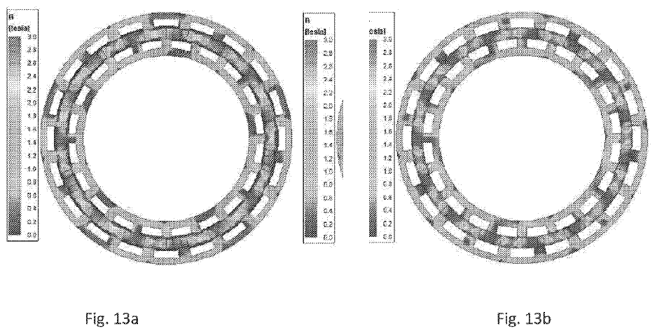

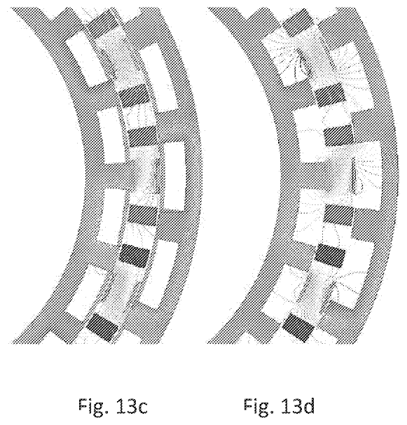

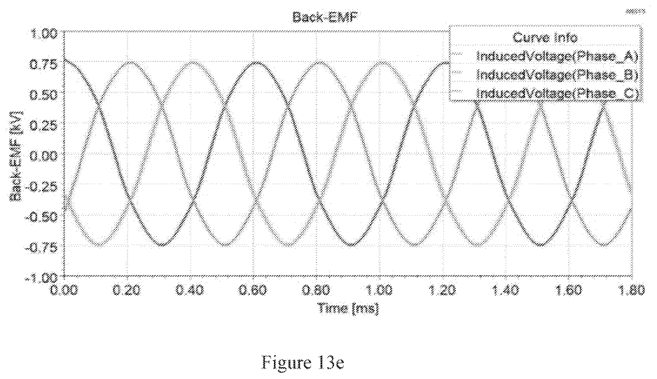

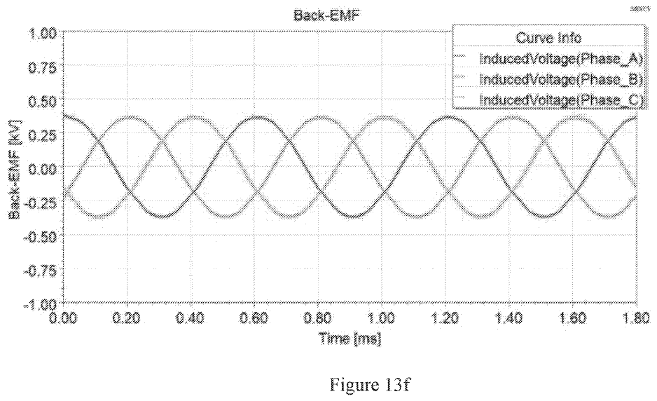

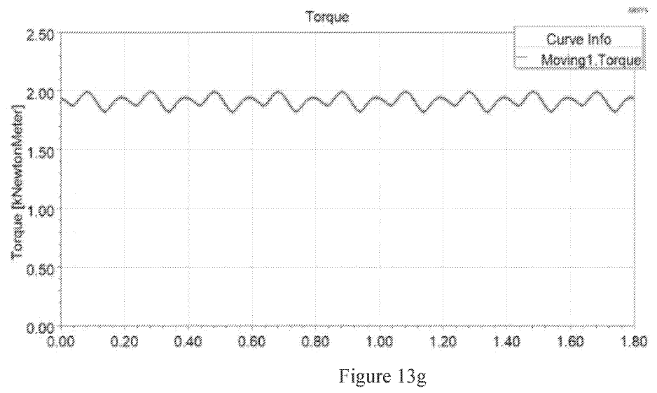

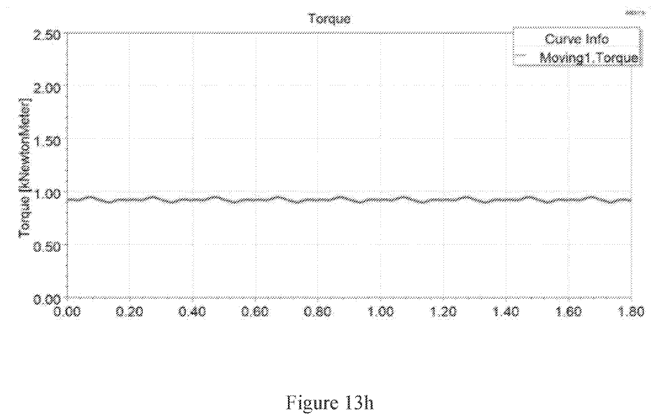

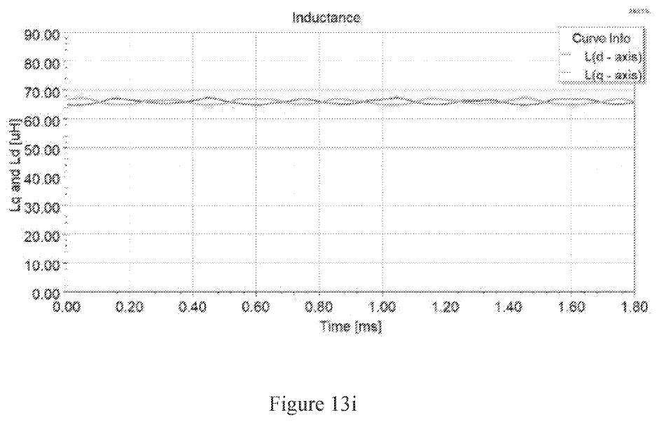

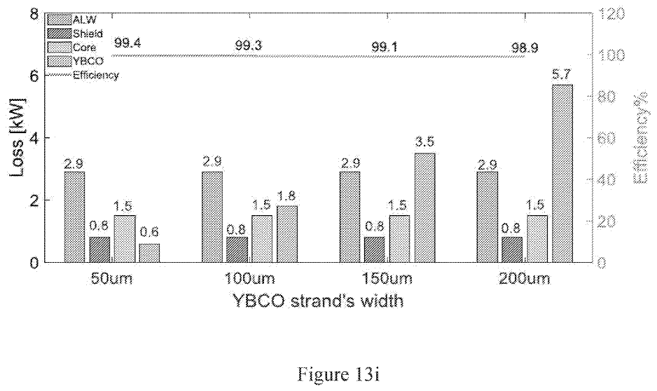

The FE model is built using the physical dimensions in Table IF. The number of turns per each HTS coil is N_{f fcoil}=85, and the number of turns per each armatures winding is N_{a,winding}=70. Under the given operating conditions, the engineering current density of YBCO and the current density of ALW are 2890 A/mm² and 220 A/mm², respectively. The DRFSM with the shield is operated at a mechanical speed of 5000 RPM with a given field excitation current of I_{dc}=533 A. The sinusoidal armature current of I_{ALW}=640 A is fed as the input RMS current to the motor. With the given input conditions, it can be confirmed that an output power of 1 MW is secured at rated operating conditions. Under the given operating conditions, the FE model of the FSM motor with and without shield is shown in FIG. 13a-13b. It illustrates the flux density distribution of the machines under full-load operating conditions.

The flux lines of the FSM with and without a superconducting shield in full-load conditions are given in FIG. 13c-d. From the given figures, it is evident that the flux is guided by the superconducting shield, which reduces the leakage flux in the machine. Eventually, the magnitude of the Back-EMF will increase, further increasing the motor's average power under the given operating conditions. This substantial increase in motor power manifests the significance of superconducting shields. Thus, for the two identical motors of the same physical dimensions, it is found that the average power and torque are more for the motor with the shield. Additionally, while evaluating the power density of the machine, it was again found that the motor with a shield possesses better power density (kW/kg) than the motor without shields.

The back-emf and torque of DRFSM with shield and without shield are shown in FIG. 13e-h. It is shown that the backemf and torque of FSM with a superconducting shield are almost two times that of DRFSM without the shield. The RMS value of back-emf at the rated operational speed for DRFSM with the shield is found to be E_{B}=526.6 V. The maximum output torque obtained at the rated condition is Tₑ=1912.8 N·m. and the torque ripple is 9.35%

FIG. 13i shows the inductance in the q and d axis for the 20-pole/15-slot DRFSM with the superconducting shield. The average value of L_{d} and L_{q} for the motor is 65.92 uH and 65.96 uH, respectively. This confirms that the inductance of the proposed motor is in the acceptable range. It is also seen that there is negligible saliency in the designed motor

Table IX shows the 20-pole/15-slot DRFSM with a superconducting shield with different outer diameters. In these simulations, the outer diameter is fixed, and optimization has been done to have maximum power density along the considered limitation for torque ripple, inductance, and maximum magnetic field on the rotors.

TABLE IX
20-POLE/15-SLOT DRFSM WITH SUPERCONDUCTING
SHIELD WITH DIFFERENT OUTER DIAMETER.

| Diameter | Stack length | Power density |
|---|---|---|
| [mm] | [mm] | [kW/kg] |
| 216 | 198.4 | 51 |
| 246 | 108.8 | 74.1 |
| 276 | 75.3 | 91.2 |
| 306 | 60.1 | 100.5 |

According to table IX, with increasing the outer diameter, the power density increases; however, the length of the motor decrease. Table X shows the power density of FSM with the superconducting shield for different pole/slot combinations while the outer diameter of all designs is 306 mm, and the output power of all motors is 1 MW. The optimization has been done to have maximum power density for each pole/slot combination.

TABLE X
Power density and stack length of DRFSM with superconducting
shield for different pole/slot combination with 1
MW output power and 306 mm outer diameter

| | Stack length | Power density |
|---|---|---|
| Pole/Slot | [mm] | [kW/kg] |
| 7/6 | 110 | 41.3 |
| 12/9 | 106.5 | 53 |
| 16/12 | 76.6 | 76.6 |
| 20/15 | 60.1 | 100.5 |

Table X shows that the power density increases and stack length decrease with increasing poles and slots number. Therefore the volume of the motor decrease, and the volumetric power density increases along with the gravimetric power density. The loss components for the proposed motor include core losses (P_{c}), ALW loss (P_{Al}), YBCO loss (P_{YBCO}) and superconducting shield loss (P_{shield}). The total losses P_{T} in the machine can be found from

$${P}_{T} = {P}_{shield} + {P}_{Al} + {P}_{YBCO} + {P}_{C}$$

The superconducting shield losses which comprise of hysteresis loss and eddy current loss are calculated from (4)(8). The hysteresis loss includes both losses from parallel and perpendicular magnetic field to the surface of superconducting shield P_{hy}=P_{hy∥}+P_{hy⊥} are calculated using the formulae in (i). The ALW losses and YBCO losses are calculated using the formulae in (i) and (ii). The core losses P, for motor is computed from the FE analysis. FIG. 13i shows the losses and efficiency with different width of strands of YBCO for 20-pole/15-slot FSM with superconducting shield and 306 mm diameter. According to FIG. 13i, with increasing the width of the YBCO filament, the YBCO AC losses increase. Therefore, the efficiency of the motor decreases. Table XI shows the efficiency of 20-pole/15-slot for different outer diameters with different YBCO strand's widths.

TABLE XI
EFFICIENCY OF 20-POLE/15-SLOT DRFSM WITH SHIELD
FOR DIFFERENT OUTER DIAMETER DESIGNS

| Diameter | Efficiency | Efficiency | Efficiency | Efficiency |
|---|---|---|---|---|
| [mm] | (50 um) | (100 um) | (150 um) | (200 um) |
| 216 | 99.46% | 0.99.1% | 98.8% | 98.43% |
| 246 | 99.46% | 99.2% | 98.96% | 98.66% |
| 276 | 99.41% | 99.2% | 98.97% | 98.68% |
| 306 | 99.4% | 99.3% | 99.1% | 98.9% |

Table XII compares the efficiency of DRFSM's for different pole/slot combinations with the superconducting shield. As seen in Table XII, a lower number of poles has lower electrical frequency; therefore, the loss decreases and the efficiency of the motor increases while the power density decreases.

TABLE XII
EFFICIENCY OF DRFSM WITH SHIELD FOR
DIFFERENT POLE/SLOT COMBINATIONS

| | Efficiency | Efficiency | Efficiency | Efficiency |
|---|---|---|---|---|
| Pole/Slot | (50 um) | (100 um) | (150 um) | (200 um) |
| 7/6 | 99.45% | 99.36% | 99.24% | 99.1% |
| 12/9 | 99.5% | 99.35% | 99.2% | 99% |
| 16/12 | 99.45% | 99.35% | 99.17% | 98.95% |
| 20/15 | 99.4% | 99.3% | 99.1% | 98.9% |

Thus, numerical modeling shows that a DRFM with superconducting magnetic shields and superconducting field coils (partially superconducting machine since it employs both ALW for armature windings and YBCO superconducting tapes for field coils) gives better characteristic behavior to the motor in terms of high power, electromagnetic torque, and high power-to-weight ratio. This enhanced and improved output performance of the motor can be employed in electric aviation applications where high-power density is critical. This newly designed 20-pole/15-slot motor with shields delivers a high-power density greater than 100 kW/kg. The efficiency of the motor can be 99.4%. This validates the vital significance of shields in achieving higher power density and efficiency in the machine.

### (iv) 16 Pole/12 Slot DRFSM

TABLE XIII
PHYSICAL DESIGN PARAMETERS OF A
16-POLE/12-SLOT DOUBLE ROTOR FSM.

| | | 16-pole/ | |
|---|---|---|---|
| Parameters | Symbol | 12-slot | |
| The inner radius of | rₛₕ | 99.7 | mm |
| the inner rotor | | | |
| The thickness of the | hᵣᵢ | 8 | mm |
| inner rotor ring | | | |
| The thickness of the | hᵣₒ | 7 | mm |
| outer rotor ring | | | |
| Rotor tooth height | hᵣₜ | 12 | mm |
| Field coil core width | w_{c} | 20 | mm |
| Airgap length | g | 1 | mm |
| Field coil slot width | w_{f} | 4.2 | deg |
| Field coil slot length | l_{f} | 2.3 | mm |
| Rotor tooth width | wᵣₜ | 5.9 | deg |
| Stator tooth width | wₛₜ | 5.4 | deg |
| Armature winding | w_{aw} | 7 | deg |
| slot width | | | |
| Stack length | L_{satck} | 83 | mm |

The FSM was analyzed for operation at a mechanical speed of 5000 rpm, with an input current comprising a sinusoidal current with a rms value of 640 A and the field current is 1024 A. The engineering current density of YBCO and the current density of ALW are 1940 A/mm2 and 60 A/mm2, respectively. The number of turns per each HTS coil is N_{fcoil}=38, and the number of ALW armatures winding turns for each phase is N_{winding}=64. To show the effectiveness of the superconducting shield, the motor with and without a superconducting shield was simulated with the same operating conditions and dimensions. With the given conditions, it can be confirmed that an output power of 1 MW is secured at rated operating point. The thermal losses of the motor components are cooled with flowing two-phase gas/liquid flow or liquids through manifold structures and components. For motor components operating from 65K to 95K, cooling is achieved using the cooling capacity of liquified-natural-gas (LNG) fuel (third example)

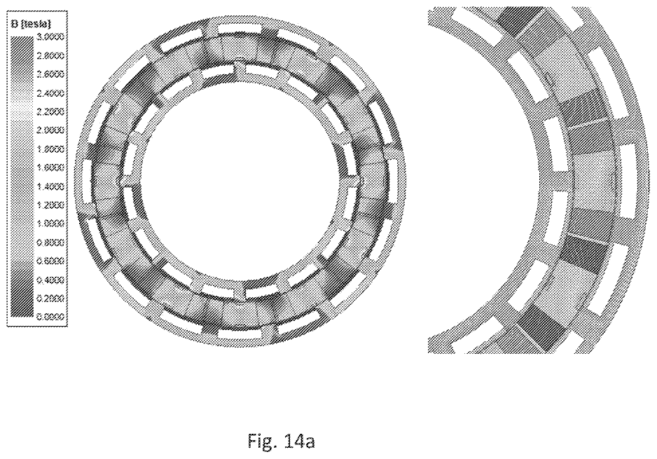

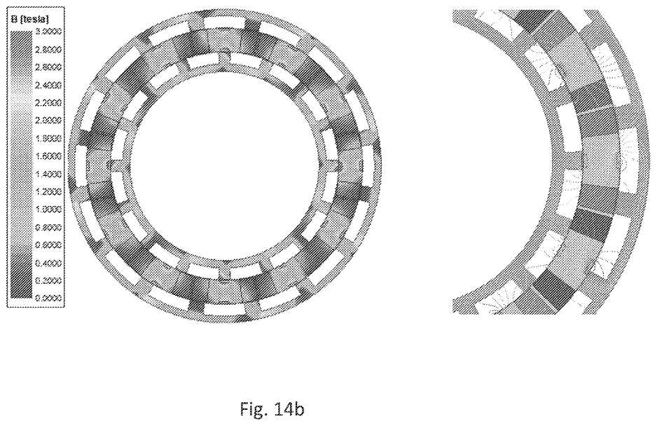

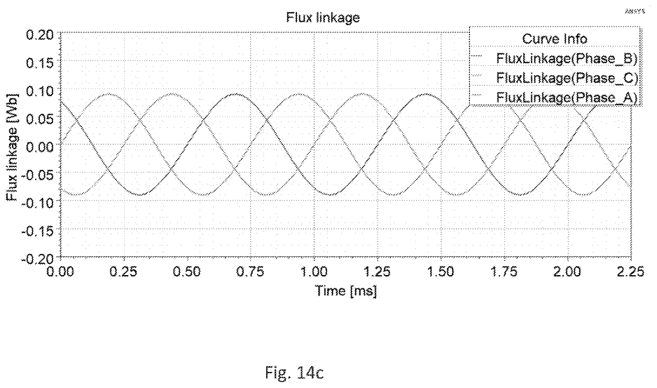

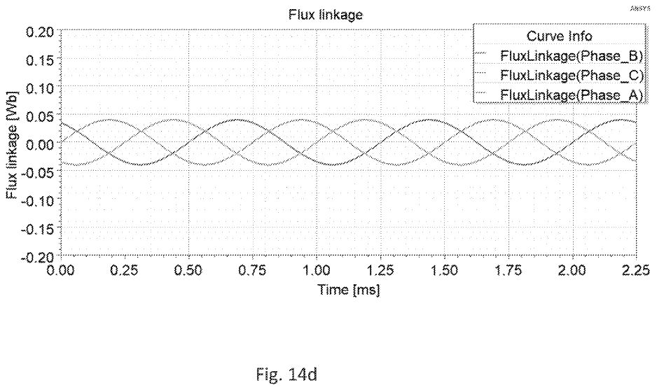

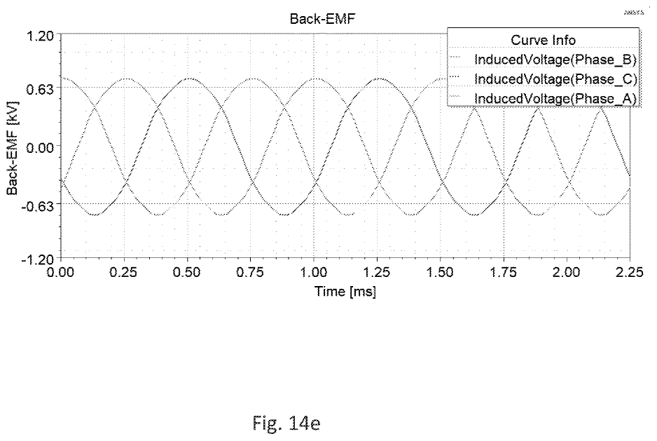

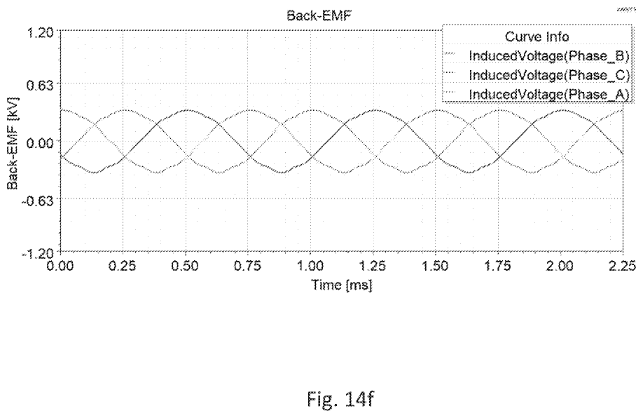

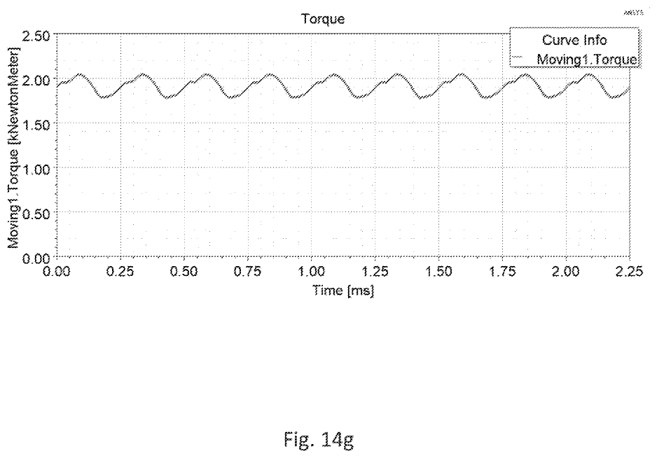

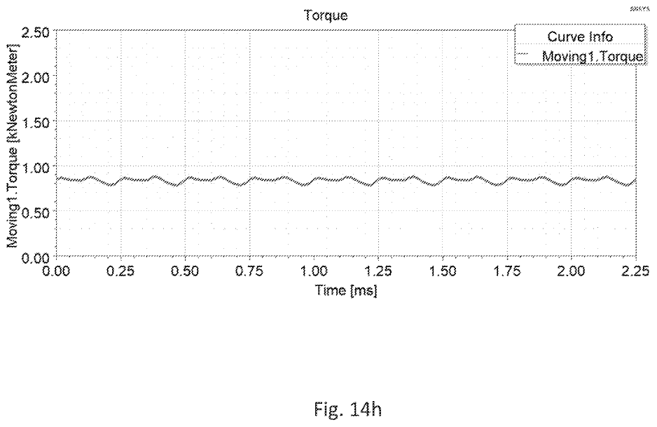

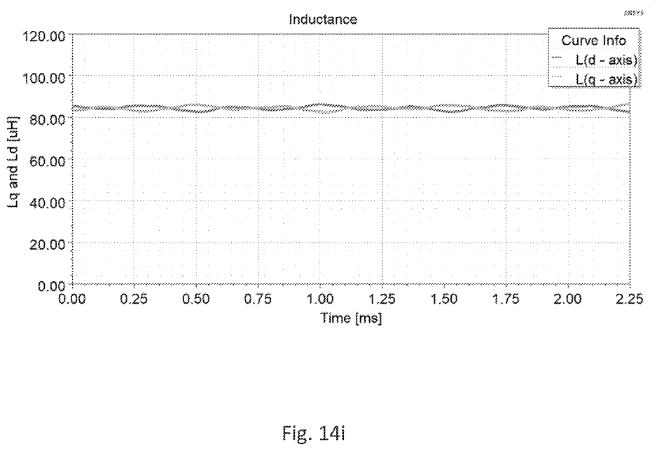

The FE model of the proposed motor with and without a shield is shown in FIG. 14. It illustrates the flux density distribution and the flux lines of the proposed motor with and without a superconducting shield under full-load operating conditions, and shows maximum magnetic field is less than 2.4 T. Therefore, the rotors are not saturated in both models. As for the above described implementations, FIG. 14 shows the flux is guided by the superconducting shield, which reduces the leakage flux in the machine. Eventually, the magnitude of the back-EMF will increase, further increasing the motor's average power under the given operating conditions. This substantial increase in motor power manifests the significance of superconducting shields. Thus, for the two identical motors of the same physical dimensions, it is found that the average power and torque are higher for the motor with the shield in comparison to the same motor without the shield. The flux linkages and back-EMF of the double rotor FSM with shield and without shield are shown in FIG. 14c and FIG. 14d. According to FIG. 14c the maximum value of flux linkage for design with shield is 90 mWb and for design without shield is 40 mWb. The rms value of the motor back-EMF with the superconducting shield is 525 V for design without superconducting shield is 234 V. FIG. 14g-h shows the torque waveform of design with and without superconducting shield.

The flux linkage, back-emf and torque of design without shield is almost half of design with shield. The average torque is found to be 1911 N·m and the torque ripple is 13.9% with the given armature current and operating speed for design with superconducting shield. The output power is 1 MW for the designed motor.

FIG. 14i shows the average value of L_{d} and L_{q} as 0.084mH and 0.084mH, respectively. This confirms that there is negligible saliency in the designed motor and all torque is produced by magnet torque and inductance is less than Lₘₐₓ.

For validating the feasibility of the proposed design geometry, the efficiency of the motor is calculated using the procedures described above, losses for ALW at 95 K and YBCO HTS at 65 K, but neglecting ac losses of the superconducting shield. Since the end winding of ALW and YBCO are not experiencing a variable magnetic field, they are not considered in ac loss calculations.

TABLE XIV
THE LOSSES OF DIFFERENT PART OF PROPOSED MOTOR
WITH DIFFERENT WIDTH OF FILAMENT OF YBCO

YBCO filament width

| | 50 um | 100 um | 150 um | 200 um |
|---|---|---|---|---|
| P_{YBCO=} P_{e, YBCO+} | 0.33 | 0.66 | 1 | 1.3 |
| P_{h, YBCO} [kW] | | | | |
| P_{ALW=} P_{r, Al+} | 9 | 9 | 9 | 9 |
| P_{e, AL} [kW] | | | | |
| P_{c} [kW] | 1.4 | 1.4 | 1.4 | 1.4 |

Evaluating the power density of both motors with and without superconducting shields, it was found that the motor with superconducting shields has a power density of 64.3 kW/kg, while the motor without shields has a power density of 31.4 kW/kg; more than a factor of two.

Table XIV shows the final parameters for the proposed motor.

TABLE XIV

| | YBCO filament width | | | |
|---|---|---|---|---|
| | 50 um | 100 um | 150 um | 200 um |
| Output power [kW] | 1000 | 1000 | 1000 | 1000 |
| Armature windings | 640 | 640 | 640 | 640 |
| current [A] | | | | |
| DC coils | 1024 | 1024 | 1024 | 1024 |
| current [A] | | | | |
| Efficiency | 98.94% | 98.9% | 98.6% | 98.83% |
| Active power | 64.3 | 64.3 | 64.3 | 64.3 |
| density [kW/kg] | | | | |

Similarly to the above described examples, the introduction of superconducting shields gives better characteristic behavior to the motor in terms of high power, electromagnetic torque, and high power-to-weight ratio. This enhanced and improved output performance of the motor can be employed in electric aviation applications where high-power density is critical. This newly designed motor with shields delivers a high-power density greater than 64 kW/kg; however, the effective power density was found to be 31.4 kW/kg for the same motor without shields. The efficiency of the proposed motor is greater than 98.83%. This validates the vital significance of shields in achieving higher power density with less machine losses.

(v) 12 Pole/9 Slot Comparison with 16 Pole 12 Slot Under Various Aircraft Flight Conditions

TABLE XV
PHYSICAL DESIGN PARAMETERS OF A 12POLE/9SLOT
AND 16POLE/12SLOT DOUBLE ROTOR FSM

| Parameters | Symbol | 12pole/9slot | | 16-pole/12-slot | |
|---|---|---|---|---|---|
| The inner | rₛₕ | 86 | mm | 77.6 | mm |
| radius of the | | | | | |
| inner rotor | | | | | |
| The thickness | hᵣᵢ | 10.5 | mm | 7 | mm |
| of the inner | | | | | |
| rotor ring | | | | | |
| The thickness | hᵣₒ | 10 | mm | 7 | mm |
| of the outer | | | | | |
| rotor ring | | | | | |
| Rotor teeth | hᵣₜ | 23 | mm | 12.3 | mm |
| height | | | | | |
| Airgap length | g | 0.5 | mm | 0.5 | mm |
| Rotor tooth | wᵣₜ | 8.5 | deg | 7.15 | mm |
| width | | | | | |
| Stator tooth | wₛₜ | 8 | deg | 3 | mm |
| width | | | | | |
| Stack length | L_{satck} | 215.1 | mm | 255.95 | mm |
| The outer | rₒ | 166.5 | mm | 129.9 | mm |
| radius of | | | | | |
| motor | | | | | |

The stator winding and field coils possess RMS current densities of 60 A/mm² and 1956.9 A/mm² [31]respectively. These high current density conductors are used for analysis to assess the flight peak takeoff and cruise requirements. For 12 pole/9 slot design, the number of turns per each HTS coil are N_{fcoil}=145 and the number of ALW armatures winding turns for each phase is N_{winding}=87. For 16 pole/12 slot design, the number of turns per each HTS coil are N_{fcoil}=87 and the number of ALW armatures winding turns for each phase is N_{winding}=104. Under the given operating conditions, the current densities are listed in Table XVI.

TABLE XVI
CURRENT DENSITIES OF ARMATURE AND FIELD COILS

Motor Design
(Pole-Slot
configurations)

| | 12-pole/ | 16-pole/ |
|---|---|---|
| | 9-slot | 12-slot |
| YBCO Current | 1957 | 1957 |
| density (A/mm²) | | |
| ALW current | 60 | 60 |
| density (A/mm²) | | |
| Armature Current | 160 | 160 |
| (RMS) (A) | | |
| Field Current (A) | 1030 | 1030 |

With the given current densities, and number of windings turns in each slot, the active part weight of 12 pole/9 slot and 16 pole/12 slot FSMs are 49.3 kg and 32.8 kg, respectively. The electric machine is implemented with a manifold for cooling and support of stator armature windings and superconducting field coils as described in the third example.

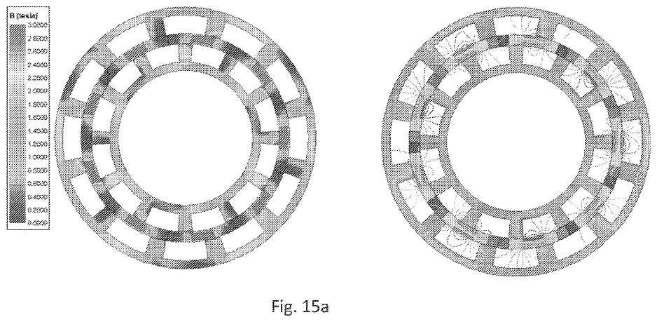

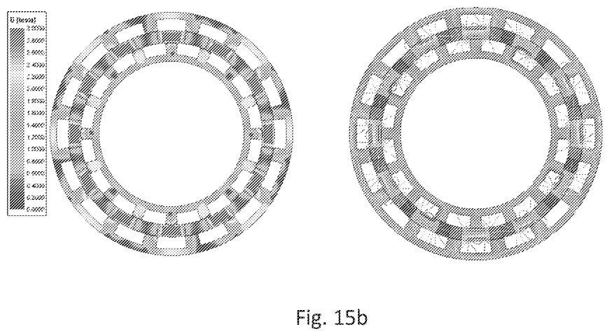

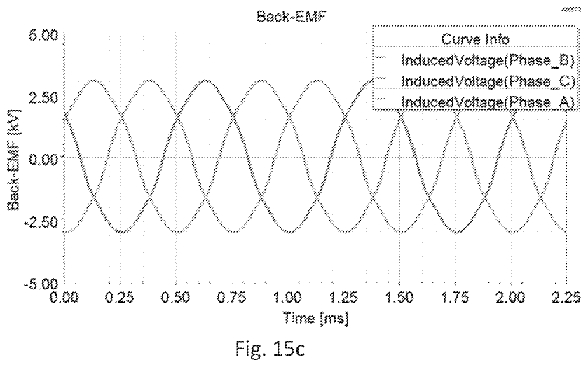

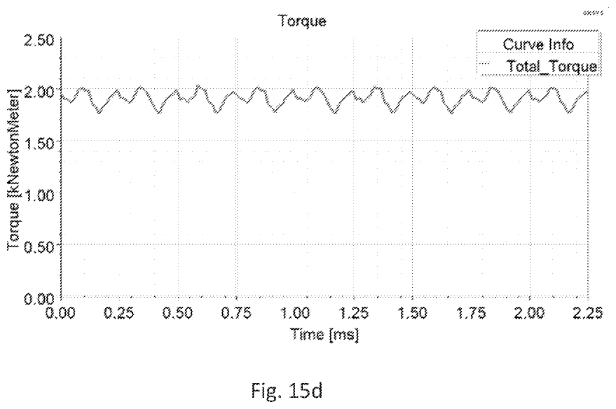

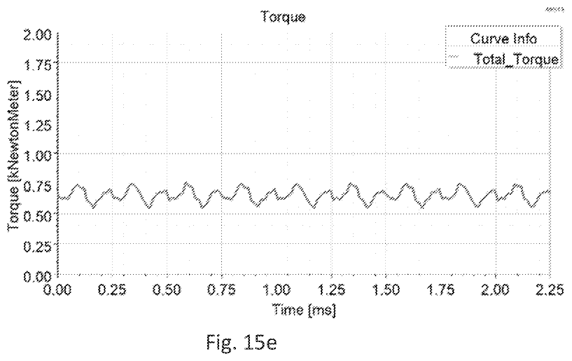

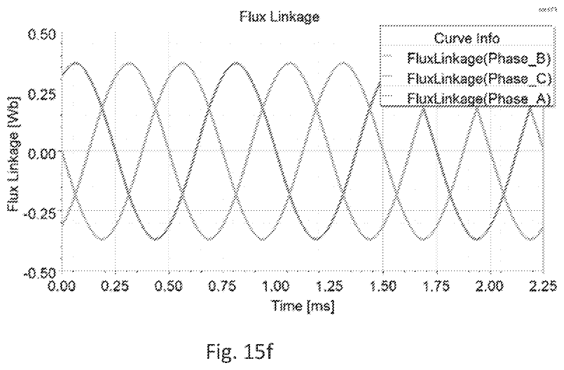

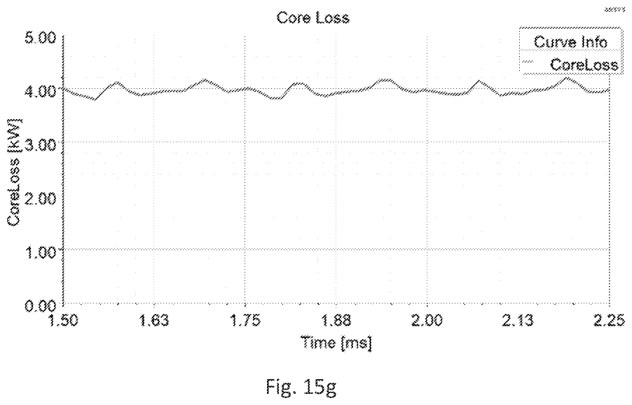

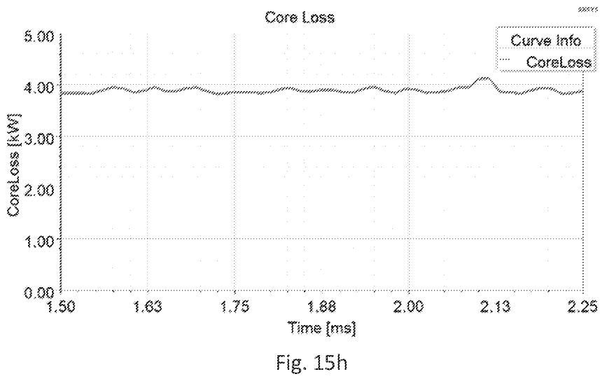

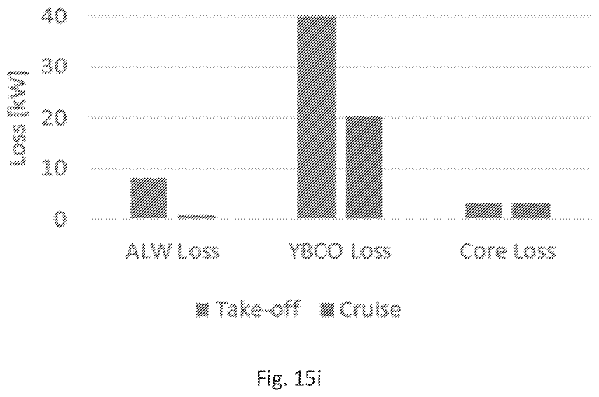

For a transient analysis, the double-rotor FSM is operated at a mechanical speed of 5000 RPM with a given field excitation current of I_{dc}=1030 A. The sinusoidal armature current of I_{ALW}=160 A is fed as the input rms current to the motor. With the given input conditions, it can be confirmed that an output power of 1 MW is secured at rated operating conditions. The performance of the machine was investigated under both take-off and cruise conditions; where under the cruise conditions the speed is 5000 rpm and the input current is ⅓^{rd} of the rated value. Under the given operating conditions, the motor back-EMF, torque, and flux linkages for a 16 pole/12 slot FSM are shown in FIG. 15c-f.

Since the motor speed and field excitation remain the same in both take-off and cruise condition, the motor back-EMF and flux linkage remain the same under both operation conditions. However, the electromagnetic torque reduces approximately to ⅓^{rd} of the rated torque under cruise condition. In addition, there will be reduction in core losses too, as the input current would be reduced significantly.

The rms value of back-EMF at the rated operational speed is found to be E_{B}=2149 V while the maximum output torque obtained at the rated conditions is T_{E}=1910 N·m. However, under the cruise condition, the electromagnetic torque is found to be 655 N·m. The maximum flux linkage of ψ=0.368 Wb is observed at the rated field excitation conditions.

With reference to the effective motor weight, which is found to be 32.8 kg, the power density of 30.5 kW/kg is accomplished with this newly designed motor. In addition to evaluate the efficiency of the proposed motor, the losses are calculated as described in the sections above. The core losses P, under both the take-off and cruise conditions are computed from FE analysis and is shown in FIG. 15g-h for one period. The total evaluated losses under take-off and cruise conditions are given in FIG. 15i. With the given losses, the motor efficiency is found to be 95.2% and 93.3% under take-off and cruise conditions respectively. The overall performance of the motors is given subsequently in Table XVII.

TABLE XVII
MOTORS PERFORMANCE.

| Performance | 12-pole/ | 16-pole/ |
|---|---|---|
| Characteristics | 9-slot | 12-slot |
| Back-EMF (RMS) (V) | 2149 | 2149 |
| (take-off and cruise) | | |
| Average Torque | 1910 | 1910 |
| (N · m) (take-off) | | |
| Average Torque | 655 | 655 |
| (N · m) (cruise) | | |
| Output power (kW) | 1000 | 1000 |
| Efficiency (take-off) | 96.1% | 95.2% |
| Efficiency (cruise) | 94.4% | 93.3% |
| Power | 20.3 | 35.5 |
| density (kW/kg) | | |

The analysis shows the motor geometry delivers high torque density and power-to-weight ratio. The employment of YBCO high temperature superconducting coils effectively reduces the weight and losses in the machine, improving both the power density and efficiency of the motor. A power density of 30.5 kW/kg is accomplished for a 16 pole/12 slot motor geometry. The efficiency under take-off and cruise conditions are found to be 95.2% and 93.3% respectively.

### Second Example: Flux Switching Machine with Second Configuration of Field Coils for Implementation of Flux Reversal in a Flux Reversal Machine

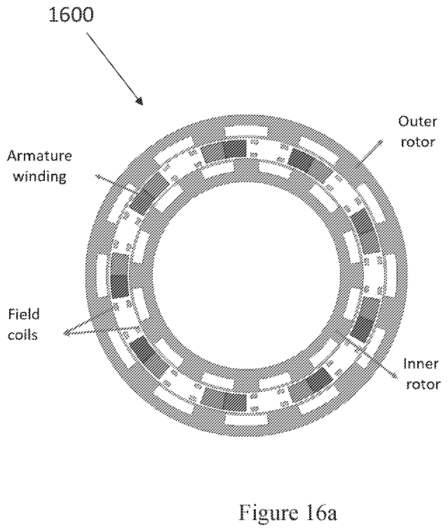

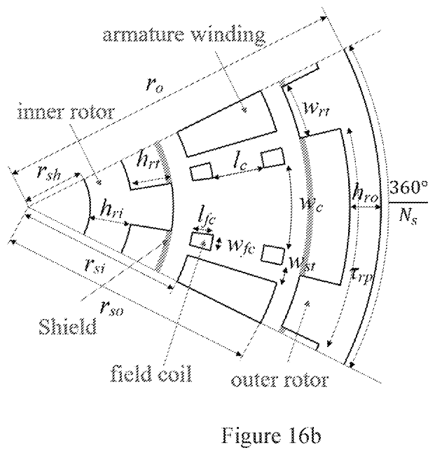

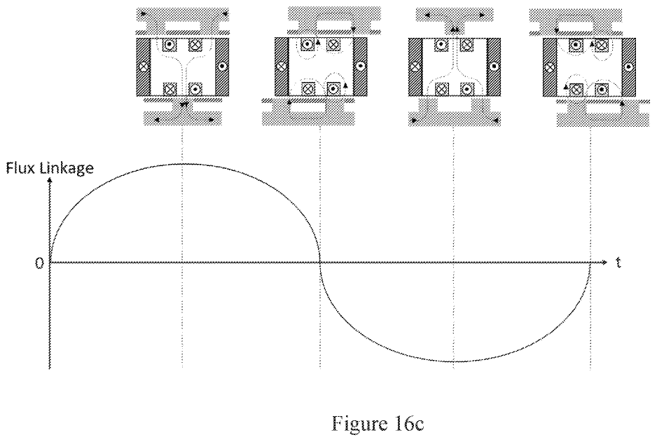

FIG. 16a illustrates an electric machine comprising double rotor flux reversal motor (DRFRM), comprising 12-poles/9-slots, a superconducting magnetic shield and HTS field coils replacing the permanent magnets. By adopting the suitable HTS field coil arrangements, the proposed machine can also achieve the same flux-linkage patterns as a Doubled-Sided Flux Reversal Linear Synchronous Motor (DSFRLSM). The inner and outer rotors are made of laminated Hiperco 50 with a thickness of 0.15 mm.

Without being bound by a particular scientific theory, the working principle of the DRFRM is shown in FIG. 16c. A magnetic flux passes through the windings (when the HTS coils are excited) and switches its direction when the rotor rotates. The generated switching flux produces a bipolar ac flux linkage in the windings.

The power density obtained with the proposed design topology is found to fulfill the targeted requirement of electric aviation [19].

a. Finite Element Analysis Results

A finite element (FE) analysis is carried out using ANSYS Maxwell, as described for the first example, using the calculation procedure for engineering current density illustrated in FIG. 7a and associated text.

The electrical motor's geometry was optimized to have maximum power density using the built-in Genetic Algorithm of Maxwell Ansys described in FIG. 7b. As describe above, the torque ripple should be less than 15%, the flux density on the rotor should be less than Bₛₐₜ to prevent rotor saturation, and the motor inductance should be less than Lₘₐₓ.

The physical dimensions of the an example motor are listed in Table XVIII.

TABLE XVIII
PHYSICAL DESIGN PARAMETERS
OF A 12-POLE/9-SLOT DRFRM

| Parameters | Symbol | 12-pole/9-slot | |
|---|---|---|---|
| The inner radius | rₛₕ | 90 | mm |
| of the inner rotor | | | |
| The thickness of | hᵣᵢ | 10 | mm |
| the inner rotor ring | | | |
| The thickness of | hᵣₒ | 10 | mm |
| the outer rotor ring | | | |
| Rotor tooth height | hᵣₜ | 12 | mm |
| Field coil core width | w_{c} | 10 | deg |
| Field coil slot | w_{fc} | 3 | deg |
| area width | | | |
| Field coil slot | l_{fc} | 3.5 | mm |
| area length | | | |
| Rotor tooth | wᵣₜ | 13 | deg |
| width | | | |
| Stator tooth | wₛₜ | 2.2 | deg |
| width | | | |
| Stack length | L_{satck} | 110.2 | mm |
| Air gap | g | 2 | mm |

In one embodiment characterized herein, the DRFRM with the superconducting shield is operated at a mechanical speed of 5000 with a field current of I_{dc}=282 A. The motor's armature current is a sinusoidal current with 640 A rms. With the given input conditions, it can be confirmed that an output power of 1 MW is secured at rated operating conditions. The number of turns per each HTS coil is N_{fcoil}=137, and the number of ALW armatures winding turns for each phase is N_{winding}=42. Under the given operating conditions, the engineering current density of YBCO and the current density of ALW are 1830 A/mm2 and 60 A/mm2, respectively. This design considers the 0.8 safety factor for engineering current density.

The motor can be operated with a thermal management system using the cooling capacity of liquified-natural-gas (LNG) fuel for motor components operating from ~65K to 95K. This includes supporting stator armature windings, superconducting field coils, and a manifold for the thermal management system (see third example).

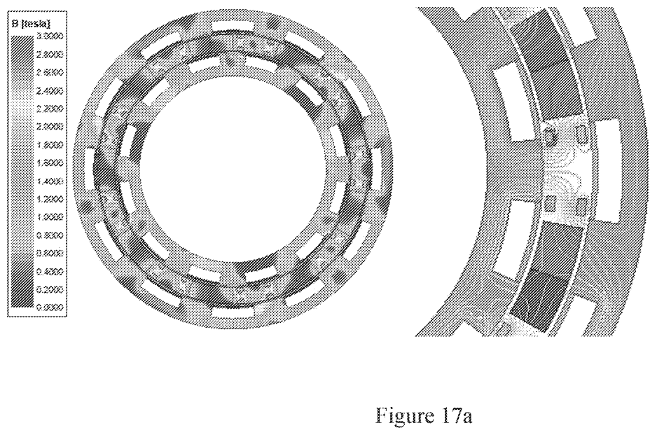

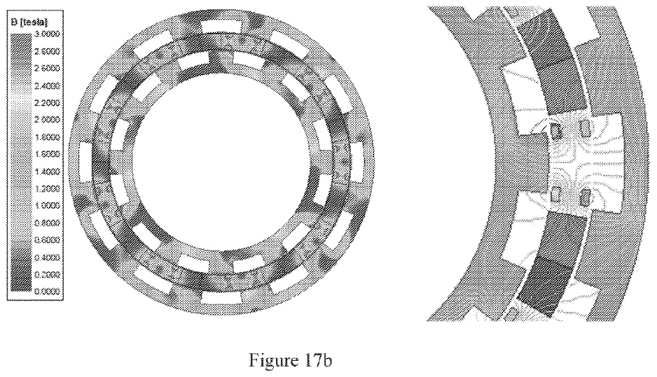

The DRFRM with and without a superconducting shield is simulated under identical operating conditions and dimensions to demonstrate the efficacy of the shield. FIG. 17 shows the flux density distribution and the flux lines of the proposed motor with and without a superconducting shield under full-load operating conditions. FIG. 17 shows that the flux density of the rotors is smaller than 2.4T and flux is guided by the superconducting shield, which reduces the leakage flux in the machine.

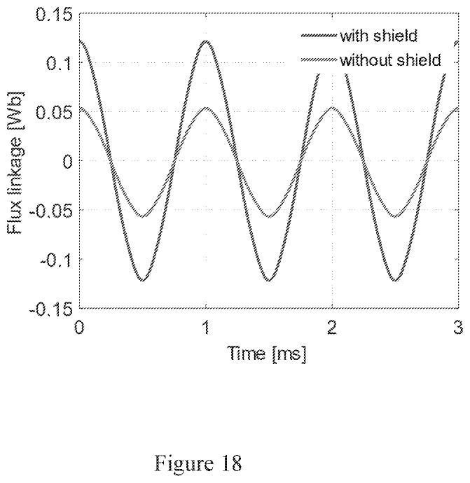

FIG. 18 shows the flux linkage of motor with and without shield. The maximum flux linkage of DRFRM with shield is 0.121 Wb and maximum flux linkage of DRFRM without shield is 0.053 Wb which confirms the effectiveness of shield.

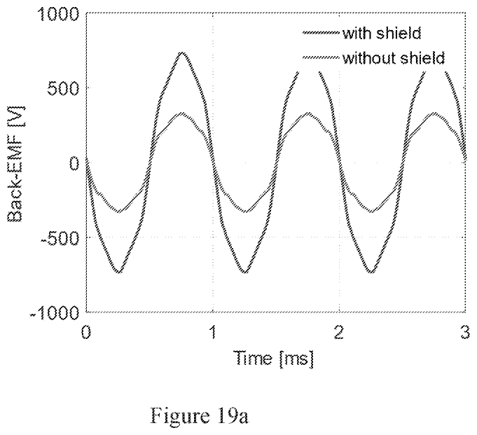

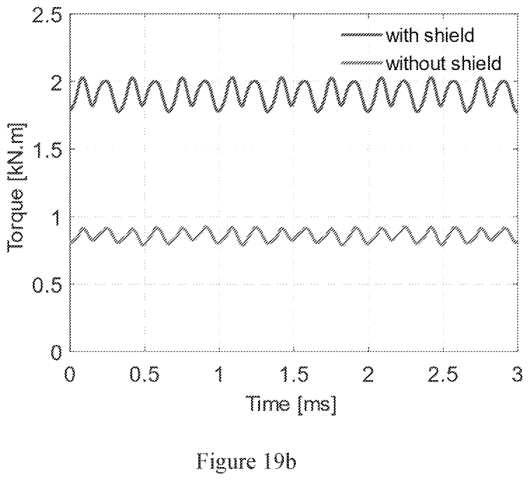

FIG. 19 shows the back-emf and torque of DRFRM with shield and without shield, illustrating that the back-emf and torque of the DRFRM with a superconducting shield are almost two times that of the machine without the shield. The rms value of back-emf at the rated operational speed for the DRFSM with the shield is found to be E_{B}=528 V. The maximum output torque obtained at the rated condition for design with shield is Tₑ 1910 N·m. and the torque ripple is 13.4%.

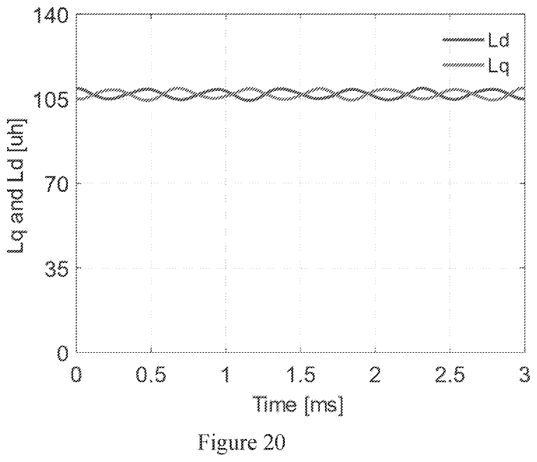

FIG. 20 illustrates a calculation of instantaneous d and q inductances for the DRFRM, showing the average value of L_{d} and L_{q} as 0.106mH and 0.106mH, respectively. This confirms that there is negligible saliency in the designed motor and inductance is less than Lₘₐₓ.

b. Efficiency Calculation

The efficiency and losses of the DRFRM were calculated. Similar to the first example, the evaluated losses include core loss P_{c}, ALW loss P_{Al} and YBCO loss P_{YBCO}. The losses of the superconducting shield is negligible [9] and the ALW losses comprise resistive loss Pᵣ and eddy current loss P_{e,AL} and are computed using the equations set forth in the first example (see (i) for 20 pole 15 slot machine). Because the end winding of armature winding and field coils are not experiencing a variable magnetic field, they are not considered in ac loss calculations [21].

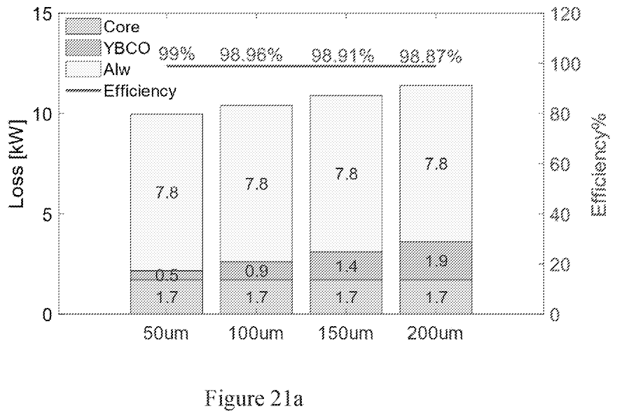

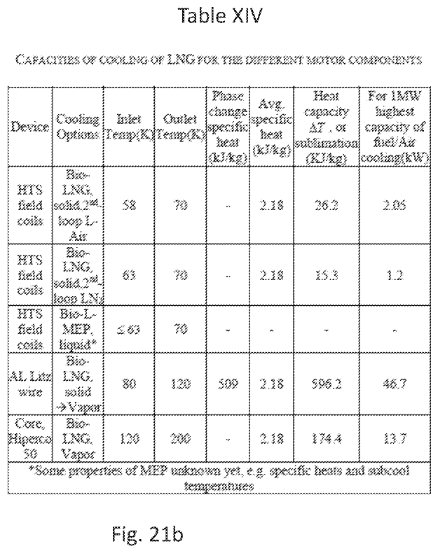

The core losses P_{c} for proposed motor is computed from the FE analysis. In [22], it is demonstrated that the racetrack coil's AC loss is 10 to 20 times smaller than single tape loss because the magnetic field is shielded by the turns above and below. FIG. 21a shows the calculated loss considering the reduction factor. According to FIG. 20, the efficiency of DRFRM can be greater than 98.87%. For the parameters presented herein, the active part weight of the motor is 24.5 kg and the active power density of proposed motor is 41 kW/kg. Table IX shows example parameters for an DRFRM.

IX FINAL PARAMETERS OF THE DRFRM

| | YBCO filament width | | | |
|---|---|---|---|---|
| | 50 um | 100 um | 150 um | 200 um |
| Output power [kW] | 1000 | 1000 | 1000 | 1000 |
| Armature windings | 640 | 640 | 640 | 640 |
| current [A] | | | | |
| DC coils | 282 | 282 | 282 | 282 |
| current [A] | | | | |
| Losses [kW] | _{≤10} | _{≤1.4} | _{≤10.9} | _{≤11.4} |
| Efficiency | _{≥99%} | _{≥98.96%} | _{≥98.91%} | _{≥98.87%} |
| Active power | 41 | 41 | 41 | 41 |
| density [kW/kg] | | | | |

Thus, the above analysis shows DRFRM with a superconducting shield and HTS field coils can also be employed in aviation applications where high power density is critical. The motor is simulated to deliver better performance characteristics in terms of high torque density and power density. As for the first example, the superconducting shield reduced the leakage flux and further increased the power density. The employment of YBCO high-temperature superconducting coils effectively reduces the weight and losses in the machine, improving both the power density and efficiency of the motor. Having an air-core stator offers additional merits of higher power-to-weight ratio and high efficiency. Based on FE analysis, the active power density of 41 kW/kg can be accomplished for a 12-pole/9-slot motor geometry. Using loss formulas, the efficiency under rated conditions was found to be greater than 98.87%.

### Third Example: Thermal Management System

In one or more examples, the thermal losses of the motor components are cooled with flowing liquids or two-phase gas/liquid flow through manifold structures and components. For motor components operating from ~65K to 95K, cooling is achieved using the cooling capacity of liquified-natural-gas (LNG) fuel, with atmospheric freezing point of 112K, subcooled as a liquid to 92K, or frozen in storage tanks to below 60K. Frozen LNG can be utilized as a coolant, by running secondary cooling lines through it of subcooled liquid N₂ at 63K or liquid-air at 58K. An alternate fuel mixture Liquid-(Methane_{0.63}Ethane_{0.16}Propane_{0.21}) (L-MEP) has an ultra-low freezing point T=63.1K, above which L-MEP can be used as a primary coolant [23].

The magnitude of losses that can be managed with LNG cooling have upper limits determined by the cryofuel volume flow at different propulsion powers, the specific heats of LNG, component operation temperatures, and Δ_{Temp} temperature rises of the components. Table XIV in FIG. 21 summarizes the capacities of cooling of LNG for the different motor components.

Cooling of the field coils can be achieved with a secondary loop of liquid N₂ entering subcooled to ~63K or liquid-air cooled to 58K, and exiting at ~70K, or the option of L-MEP as liquid down to 63.1K. Cooling of the armature coil can be achieved with several options: i) using the secondary loop of liquid/gas N₂ gas exiting from the field coils at ~70K, and warming up to ~112K, or ii) flowing LNG entering the manifold subcooled to ~92K and exiting at as a gas ~112K. The current density and ohmic and eddy current losses of the Al litz wire of the armature coil vary ~25% from 70K to 112K, and the performance of the motor would improve if the entry temperature Al litz-wire armature was ~70K compared to ~92K.

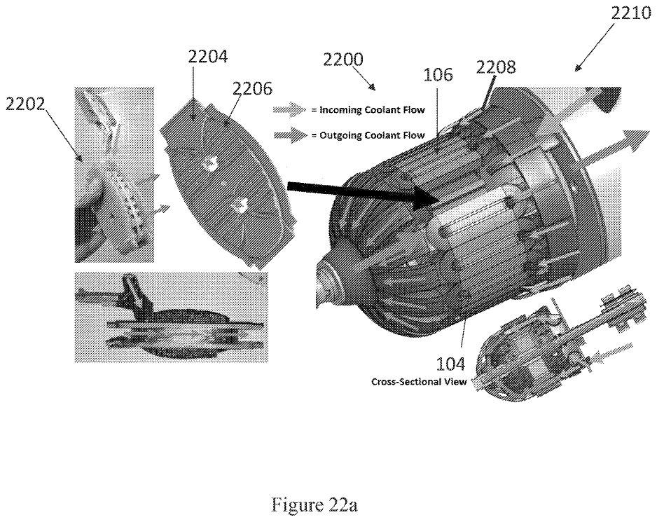

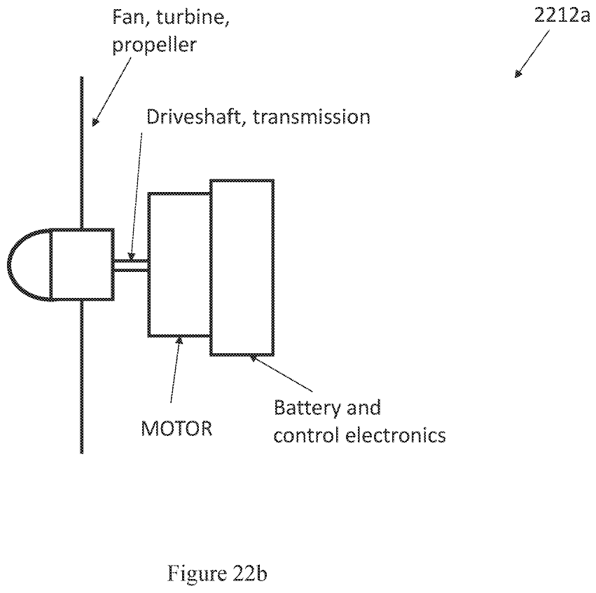

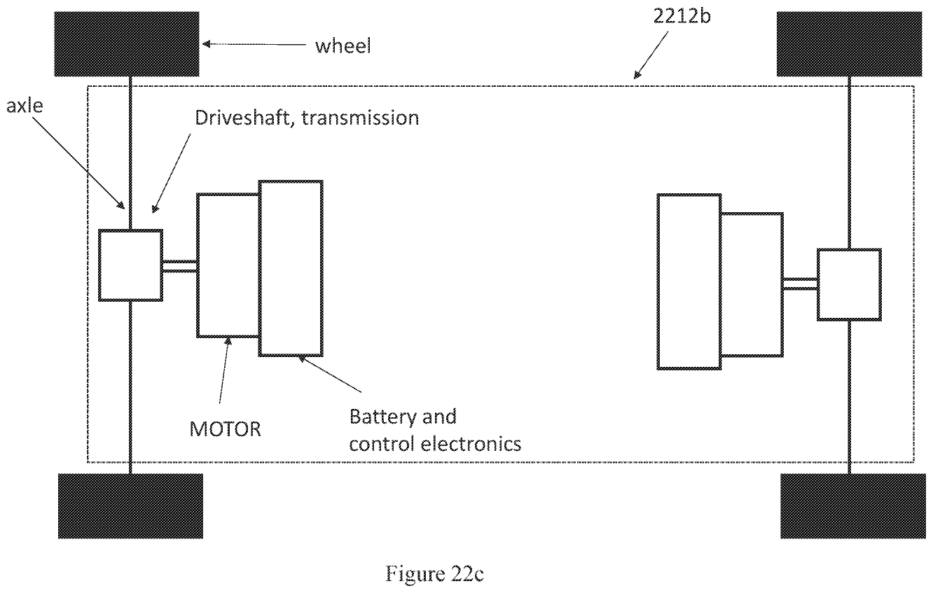

FIG. 22a illustrates an example thermal management system (TMS) connected to an electrical machine according to embodiments described herein. The armature and field coils are mechanically supported through the same fluid management manifold structures. The manifolds can be constructed out of fiber reinforced polymer composites, for example. In one example, the field coils and armature coils can be separated by Ultem 1010 pieces, and a temperature gradient can be established across the pieces with the edges at the temperature of the different flowing coolants. The field and armature coils are completely surrounded by flowing liquid/gas coolants, and can be kept at the temperature of the coolants.

In one or more embodiments, the flow of liquid LNG cryofuel in transportation vehicles such as semi-trucks can be controlled only with pressure valves and controls of the fuel system that already exist, and fluid pumps are not required. The LNG fuel is stored as liquids in cryovessels, and gas pressure builds up to ~6-10 atm from natural heat flow into the vessels, which is sufficient to push gas through fuel lines to the motor. When the gas pressure falls below ~1-2 atm, an ~1-2 kW ‘vaporizer’ can be used to heat some amount of the LNG cryofuel to burnable vapors with pressures up to- 6-10 atm. The entire process is accomplished with control devices, regulators, switches, high and low pressure gas hoses, check valves, relief valves, and other. This existing hardware is sufficient to control the flow of LNG coolant in and out of the motor, and no additional hardware is required. Also, the electric drivetrain could partially fill the role of the ‘vaporizer’ unit in the LNG fuel system, and as such the electric machine provides a new avenue reduction of the vaporizer weights and power consumption for the entire system, rather than increases typically expected.

In one or more examples, the option of secondary cooling loop of LN₂ or liquid-air is chosen, the weights even for a 1 MW drivetrain can only be ~4 kg, for helical loop tube heat exchangers and a small fluid pump ~4-5 gpm maximum. The power needed for the fluid pump can be very low, about 25 W. In this example, different from other motor designs that rely on conduction cooling, the field coil and armature are in series force-flow cryogenic fluid cooled, and experience a small delta T (<30K) between them on the exterior of their respective manifolds. The separating material between both of these fluid regions is constructed of low thermal conductivity epoxy-fiber composite. This results in a negligible heat flux from the armature to the field coil which does not require a vacuum jacket.

In various examples, the rotors, and accompanying air gap, can cooled with cryogenic air/N2/etc. vapor-mist to keep the rotors cool. This again results in low heat flux between the windings and the air gap, and does not require a thick vacuum cryostat in the air gap region. The only vacuum cryostat in this design surrounds the entire motor, separating the cryogenic motor from the ambient. No motor internals within the vacuum cryostat experience a large heat flux between neighboring regions.

### Fourth Example: Electric Machine Providing Electric Power for an all Electric Powertrain System

FIGS. 22b and 22c illustrate Electric machines 100, 200, 2210, 2400 according to embodiments described herein can be configured to provide power in an all electric power train 2212a, 2212b, for example having the specifications in Table X.

TABLE X
TECHNICAL DESIGN TARGETS FOR ALL-
ELECTRIC POWERTRAIN SYSTEM [32]

| | Target | |
|---|---|---|
| Design Description | Specifications | |
| Power Output | ≥250 | kW |
| Maximum rotational | 5000 | RPM |
| speed at takeoff | | |
| Takeoff and climb | ≥93% | |
| average efficiency | | |
| Specific power density | ≥12 | kW/kg |
| at takeoff and climb | | |
| Cruise rotational speed | 3500-4500 | RPM |

| | |
|---|---|
| Average cruise efficiency | ≥93% |

In one example study of a 5-hour-plus flight profile [32], the takeoff and climb period (power consumption 83-250 kW) typically takes 20 minutes, while most of the remaining flight time is occupied in cruise conditions; containing maximum energy consumption (power consumption less than 83 kW). A 1 MW double-rotor FSM motor with HTS field coils was designed and optimized to achieve power density ≥20 kW/kg while the efficiency under both takeoff and cruise period of a flight was ≥93%.

FIG. 22b illustrates a power train for aircraft propulsion or a turbine, and FIG. 22c illustrates a power train for a vehicle such as an automobile or truck.

### Fifth Example: Process Steps

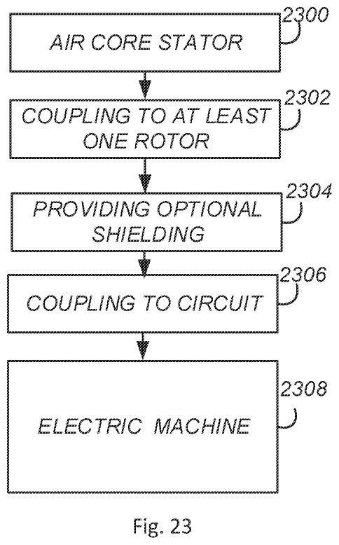

FIG. 23 is a flowchart illustrating a method of making an electric machine according to one or more embodiments.

Block 2300 represents providing an air core stator containing one or more field coils and one or more armature coils. In one or more examples, the field coils comprise a high temperature superconductor (HTS). The HTS coils can be made from any superconducting technology including, but not limited to, at least one of Yttrium Barium Copper Oxide (YBCO), Bismuth Strontium Calcium Copper Oxide (BSCCO), other HTS cuprates (Tl-cuprates, Hg-cuprates), or Magnesium Diboride (MgB2). The armature winding or coils can be made of non-superconducting material such as (but not limited to) Aluminum Litz wire or Copper Litz wire at cryogenic temperatures which have high current density and small resistivity. The armature winding could also be made from superconducting material.

In one or more examples, an air core stator comprises stator wherein everything in the air core stator, except for the support structure(s) for the field coil 104 and the armature coil 106, is air.

Block 2302 represents providing (e.g., fabricating) at least one rotor and coupling the stator to the at least one rotor. The rotors employ a material capable of high flux density such as laminated HiperCo-50 soft iron magnetic material. HiperCo-50 is an iron-cobalt vanadium alloy with a high magnetic saturation of ~2.4 Tesla and low magnetic hysteresis loss.

Block 2304 represents optionally coupling superconducting shields (e g. passive superconducting shields). Placement of the shielding between two adjacent poles (e.g., on the rotor at interpole locations and at the same level of the rotor teeth height) provides effective guidance of the magnetic flux, e.g., to pass through the rotors and armature windings, e.g., towards the rotor teeth, thereby reducing flux leakage. This results in reduction/minimization of flux leakage increases the rotor magnetizing flux and ultimately increases the power density of the machine, e.g., by approximately a factor of two over a comparable machine without shielding. In one or more examples, the superconducting shield is reproduced by setting a conductor of high conductivity and very low permeability [9] and [13].

Block 2306 represents optionally connecting a circuit to the coils in a motor or generator configuration.

Block 2308 represents the end result, an electric machine (e.g., but not limited to, a radial electric machine (e.g., flux machine) or an axial electric machine, e.g. axial flux machine).

Examples of the electric machine include, but are not limited to, the following (referring also to FIGS. 1-23).
1.An electric machine 100, 200 comprising:
an air core stator 102 comprising field coils 104 and armature coils 106, wherein the field coils comprise a superconductor; and
at least one rotor (e.g., magnetically salient) 108 coupled to the air core stator.
2. The electric machine 200 of example 1, further comprising a superconducting shielding 202 between poles 204 of the at least one rotor 206
3. The electric machine of example 1 or 2, wherein:
the at least one rotor 108 further comprises:
   a first rotor 110 comprising first rotor poles 112 and first air spaces or non-magnetic slots 114 between the first rotor poles; and
   a second rotor 116 comprising second rotor poles 118 and second air spaces or non-magnetic slots 120 between the second rotor poles, the first rotor and the second rotor comprising a material having a lower reluctance than air; wherein the second rotor is positioned concentrically inside the first rotor such that the second rotor poles face the first air spaces or non-magnetic slots;
the air core stator:
   is disposed between the first rotor and the second rotor,
   comprises a core consisting essentially of air; and
   contains a plurality of pairs 122 of coils attached to the air core stator, each pair comprising at least one of the field coils magnetically coupled to one of the armature coils.
4. The electric machine of example 3, wherein the pairs of coils are attached to the air core stator such that a magnetic flux 500 generated by each of the pairs of coils is diverted into at least one of the first rotor poles 204 or at least one of the second rotor poles 208.
5. The electric machine of example 3 or 4, further comprising superconducting shielding 202 placed at interpole locations/regions 205 between the rotor poles 204, 208 of the at least one rotor 206.
6. The electric machine of example 5, further comprising the superconducting shielding 202 covering at least the first air spaces or non-magnetic slots 114 or the second air spaces or non-magnetic slots 120 between the rotor poles, so as to aid diversion of the magnetic flux 500 into the rotor poles.
7. The electric machine of any of the examples, wherein the superconducting shielding 202 comprises a tape 1100 comprising at least one of a machined bulk melt textured solid high temperature superconductor (HTS), pressed and sintered polycrystalline HTS, a laminated HTS coated-conductor composite stack, or a heterostructure comprising a non-superconductor layer between superconductor layers.
8. The electric machine of any of the examples, wherein:
the superconducting shielding 202 comprises a layer or tape 1100 having a solid superconductive cross-section perpendicular to a magnetic flux 500 in the interpole regions 205, comprising the air spaces or non-magnetic slots 114, 120 between the rotor poles 204, 208, to prevent the magnetic flux leaking through the superconductive shielding, and
any gaps in the superconductive shielding 202 perpendicular to the magnetic flux 500 in the interpole regions 205 are smaller than a penetration depth of the superconducting shielding to prevent penetration of the magnetic flux 500 into the gaps.
9. The electric machine of any of the examples, wherein the superconducting shielding 202 comprises a high temperature superconductor (HTS) comprising at least one of a cuprate, an iron-based superconductor, or MgB₂ having a critical temperature above 20 K.
10. A motor 512a, 2210 comprising the electric machine 100, 200, 1600 of any of the examples 1-9, further comprising:
a circuit 502 connected to the field coils 104 and the armature coils 106, wherein, for each of the pairs 122 of coils:
the armature coils 106 generate magnetic flux in 500 response to a first current 504 inputted from the circuit, and
the field coil 104 generates a stator magnetic pole 508 (e.g., aligned along a circumferential direction 510 of the air core stator) in response to a second current 506 inputted from the circuit, the stator magnetic pole causing a diversion of the magnetic flux 500 into the at least one of first rotor poles 112 or the second rotor poles 118, and
the diversion of the magnetic flux 500 along the stator magnetic pole 510 and into the at least one of the rotor poles 112, 118 causes a rotation 126 of at least one of the first rotor 110 or the second rotor 116 so as to increase alignment of at least one of the rotor poles 118,112 with the stator magnetic pole, thereby outputting torque to a component coupled to the rotation 126.
11. A powertrain 2212, 2212a, 2212b for an aircraft (e.g., comprising an aircraft propulsor) or a vehicle (e.g., driving a vehicle wheel or transmission), or a turbine, powered by the motor 2210 or of example 11, or the motor 2210 of example 11 configured for providing motive power to the vehicle wheel, propelling an aircraft, or rotating the turbine, or the electric machine 100, 2400 of any of the examples configured to use as a motor in an aircraft or vehicle powertrain used for propelling the aircraft or vehicle.
12. An electric generator 512b comprising the electric machine of any of the examples, further comprising a circuit 502 connected to the field coils and the armature coils, wherein, for each of the pairs of the coils,
the field coils 104 form stator magnetic poles 508 (e.g., aligned along a circumferential direction 510 of the air core stator), the stator magnetic poles generating a magnetic flux, in response to a first current inputted from the circuit, and
a second current is induced in the armature coils and outputted to the circuit in response to an interaction of the rotor poles with the magnetic flux caused by a rotation of at least one of the first rotor or the second rotor.
13. The electric machine of any of the examples 1-12, further comprising a circuit 502 connected to the pairs 122 of coils generate a magnetic flux 500 and switching the magnetic flux between the rotor poles 118, 112 in response to sequential excitation 514 of the pairs of coils by the circuit 502.
14. The electric machine of example 13, wherein the coils 106, 104 are positioned and the sequential excitation is such that the switching comprises a reversal 516 of the magnetic flux 500 so that the linkage 512 of the magnetic flux has a polarity reversing periodically between:
a first direction 520a from one of the first rotor poles 112 to one of the second rotor poles 118, to
a second direction 520b from one of the second rotor poles 118 to one of the first rotor poles 112.
15. The electric machine of any of the examples, wherein:
the armature coil 106 comprises or consists essentially of at least one of aluminum Litz wire or copper Litz wire,
an exterior of the wires in the field coil 104 comprises a coating comprising or consisting essentially of a superconductor, or the field coil comprise or consists essentially of a superconductor, and
the at least one rotor 108 comprises or consists essentially of an iron-cobalt vanadium alloy or a laminated iron-cobalt vanadium alloy.
16. The electric machine 100, 200, 1600 of any of the examples, further comprising a cryogenic cooling system 2200 thermally coupled to the air core stator for cooling the armature coil 106 and the field coil 104 to a temperature of above or below 20 Kelvin.
17. The electric machine of example 16, wherein the cooling system comprises a plurality of coolant manifolds 2202 mechanically supporting each of the pairs 122 of coils 104, 106, wherein each of the coolant manifolds comprise an electrically insulating polymer 2204 separating and supporting the field coils 104 and armature coil 106 in each pair and a coolant system 2206 (e.g., fluidic system or system of conduits) thermally coupling the coils to a flowing coolant 2208.
18. The electric machine of example 3, wherein:
the first rotor 108, the second rotor 116, and the air core 102 stator comprise concentric annular rings 130a, 130b, 130c about a central axis 300,
for each of the pairs 122 of the coils 104, 106,
   the field coil 104 comprises a field winding 530 disposed within, surrounded by, or inside an opening 532 of the armature coil 106 comprising an armature winding 534,
   armature wires of the armature winding are concentric about an armature axis 536 oriented along a radial direction from the central axis 300, and
   field wires of the field winding 530 are concentric about a field axis oriented along a circumferential direction perpendicular to the radial direction, and
   a core of the field coil comprises or consists essentially of air, or the field coil is coiled around air.
19. The electric machine of example 18, wherein:
each of the pairs of coils comprises a plurality of the field coils disposed with, surrounded by, or inside the opening of the armature coil, and
the first rotor poles and the second rotor poles comprise teeth spaced a half pitch apart.
20. The electric machine of any of the examples, comprising: first rotor poles and 20 second rotor poles and 15 pairs of the coils, or
7 first rotor poles and 7 second rotor poles and 6 pairs of the coils, or
16 first rotor poles and 16 second rotor poles and 12 pairs of the coils, or
12 first rotor poles and 12 second rotor poles and 9 pairs of the coils.
These are merely provided as examples, the machine can have any number of poles and slots.
21. The electric machine of example 3, further comprising a circuit 502 connected to the pairs 122 of coils 104, 106, wherein:
the armature coil 106 in each of the pairs of the coils, associated with a given one of a plurality of phases A, B, C (see FIG. 5c) excited by the circuit 502, are electrically connected in series for simultaneous excitation by the circuit 502 with a current 504, and
the current 504 in each of the phases A, B, C is out of phase with the current in another of the phases.
22. The electric machine of example 21, wherein all the field coils are connected in series.
23. The electric machine of example 21, comprising a number Nₚₒₗₑ of the rotor poles, a number Nₛₗₒₜ of the pairs of coils, and a number m of the phases, wherein

$${N}_{pole} = {N}_{slot} ( 2 \pm \frac{n}{2 m} )$$

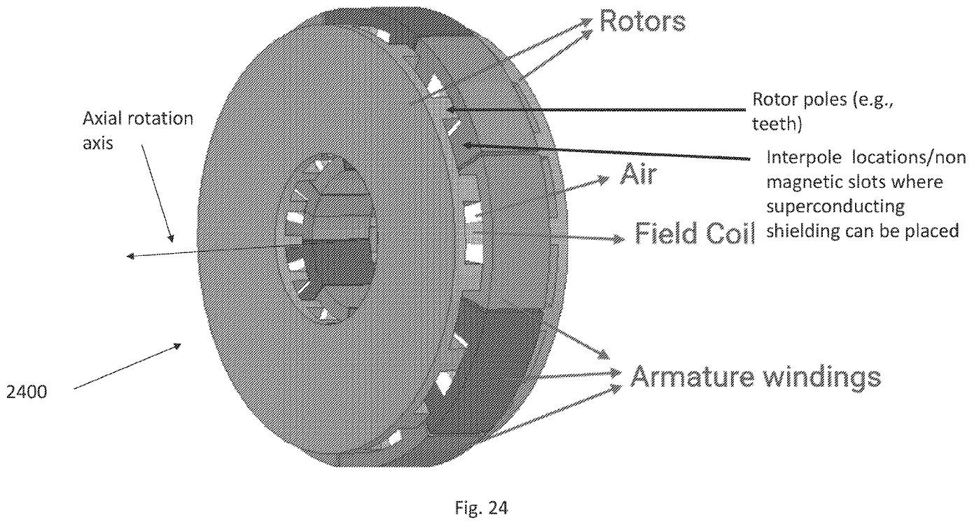

Nₚₒₗₑ is optionally in a range of 7-20 for example. However, the electric machine can have any number of poles and slots.
24. The electric machine of any of the examples, wherein the electric machine comprises a flux switching machine 100 comprising a plurality of the at least one rotor and the air core stator between a pair of the rotors.
26. The electric machine of example 24, wherein the flux switching machine comprises a flux reversal machine 1600.
27. The electric machine of any of the examples 1-26, wherein everything in the air core stator, except for the support structure(s) for the field coil 104 and the armature coil 106, is air 301. An example of support structure for the field coil and armature coil is shown in FIG. 22a (e.g., structure 2202).
28. The electric machine of any of the examples 1-27, wherein the electric machine comprises an axial machine 2400 (as illustrated in FIG. 24) wherein magnetic flux generated by the coils is along an axial direction parallel to an axis of rotation of the rotors.
29. The electric machine of any of the examples 1-27, wherein the electric machine comprises a radial machine 100 wherein magnetic flux generated by the coils is along a radial direction perpendicular to an axis of rotation of the at least one rotor.
30. The electric machine of any of the examples, 1-29 wherein the at least one motor comprises teeth or protrusions projecting towards the armature coils.
31. The electric machine of any of the examples 1-30, wherein the superconducting shielding is attached to the rotor or the stator.
32. The electric machine of any of the examples, wherein the field coils can be made of YBCO superconducting coated conductor and operate at 65K, while Aluminum Litz wire can be employed for the armature windings and operate at 95K. YBCO coated conductor is suitable for the field coils because of good Jc−B characteristics and wide temperature margin and its density is 6 3 g/cm³. The no-insulation choice for the field YBCO field coils ensures high superconducting stability. The density of Aluminum Litz wire is 2.7 g/cm³, and it has a lower resistivity and greater achievable current density at cryogenic temperatures: its low mass density leads to having a high-density motor. The double rotor FSM with HTS coils is tightly packed and its power density for 15-slot/20-pole and 250 kW is 41.2 kW and for 1 MW is N7 kW/kg.
33. The machine of any of the examples 1-32, wherein the machine can contain passive superconducting shields, Placement of the shielding on the rotor at interpole locations and at the same level of the rotor teeth height provides effective guidance to the magnetic flux towards the rotor teeth and reduces flux leakage. The minimization of flux leakage increases the rotor magnetizing flux and ultimately increases the power density of the machine by approximately a factor of two over a comparable machine without shielding.

### Sixth Example: Axial Machine

FIG. 24 illustrates an axial electric machine, wherein the stator comprises, contains, supports, or is attached to the armature coils and the field coils disposed so that the magnetic flux is generated parallel to an axis of rotation of the at least one rotor.

As illustrated in FIG. 24, the at least one rotor comprises teeth (e.g. protrusions) on a surface facing the coils, so that the teeth comprise poles projecting towards the armature coils.

Thus, in one or more examples, the rotors may comprise a first rotor comprising first rotor poles and first non-magnetic slots between the first rotor poles; and a second rotor comprising second rotor poles and second non-magnetic slots between the second rotor poles, the first rotor and the second rotor comprising a material having a lower reluctance than air; wherein the second rotor is positioned axially inside the first rotor such that the second rotor poles face the first non-magnetic slots. The air core stator is axially disposed between the first rotor and the second rotor, comprises a core consisting essentially of air; and contains a plurality of pairs of coils attached to the stator, each pair comprising at least one of the field coils magnetically coupled to one of the armature coils.

In one or more examples, a motor comprising the axial machine further comprises a circuit connected to the field coils and the armature coils, wherein, for each of the pairs of coils: the armature coils generate magnetic flux in response to a first current inputted from the circuit, and the field coil generate a stator magnetic pole of the air core stator in response to a second current inputted from the circuit, the stator magnetic pole causing a diversion of the magnetic flux into the at least one of first rotor poles or the second rotor poles, and the diversion of the magnetic flux into the at least one of the rotor poles causes a rotation of at least one of the first rotor or the second rotor, thereby outputting torque to a component coupled to the rotation.

In one or more examples, an electric generator comprises a circuit connected to the field coils and the armature coils, wherein, for each of the pairs of the coils, the field coils form stator magnetic poles generating a magnetic flux, in response to a first current inputted from the circuit, and a second current is induced in the armature coils and outputted to the circuit in response to an interaction of the rotor poles with the magnetic flux caused by a rotation of at least one of the first rotor or the second rotor.

The circuit can energize, excite (e.g., sequentially) or provide the current in phases for flux switching, flux reversal, motor operation, or generator operation, or other applications as described herein.

Shielding is optionally included in one or more examples. In one or more examples, the electric machine comprises a superconducting shielding between poles (at interpole locations) of the rotors. In one or more examples, the shielding can cover the non-magnetic slots between the rotor poles, so as to aid diversion of the magnetic flux into the rotor poles (teeth). In one or more examples, the shielding is attached to the rotor or the stator. In one or more examples, the shielding can be positioned analogously and using the same materials as in the radial electric machines described herein (see e.g., FIG. 2).

The materials for the rotor (e.g., HiperCo 50), stator, armature coils (e.g., ALW) and field coils (e.g., HTS) can be the same as the those used in the other examples described herein. The air core stator, apart from the support structures for the field coils, the armature coil, and the coils themselves, may comprise or consist essentially of air.

### Advantages and Improvements

FSM machines according to embodiments described herein have low weight and high power density making them suitable candidates for a variety of applications, in particular aviation applications.

The structure of the machine facilitates implementation of the mechanical and thermal designs. In addition the machine is capable of very high power density not possible with conventional designs. In one or more examples, the combination of superconducting coils, superconducting shields, air-core structure, and suitable thermal management system results in the above advantages.

### REFERENCES

The following references are incorporated by reference herein.

### References for First Example

[1] S. Huang, J. Luo, F. Leonardi, and T. A. Lipo, “A general approach to sizing and power density equations for comparison of electrical machines,” IEEE Transactions on Industry Applications, vol. 34, no. 1, pp. 92-97, January 1998.
[2] A. Gandhi and L. Parsa, “Double-Rotor Flux-Switching Permanent Magnet Machine With Yokeless Stator,” IEEE Transactions on Energy Conversion, vol. 31, no. 4, pp. 1267-1277, December 2016.
[3] A. Nasr, S. Hlioui, M. Gabsi, M. Mairie, and D. Lalevee, “Design Optimization of a Hybrid-Excited Flux-Switching Machine for Aircraft-Safe DC Power Generation Using a Diode Bridge Rectifier,” IEEE Transactions on Industrial Electronics, vol. 64, no. 12, pp. 9896-9904, December 2017.
[4] H. Nakane, T. Kosaka, and N. Matsui, “Design studies on hybrid excitation flux switching motor with high power and torque densities for HEV applications,” in 2015 IEEE International Electric Machines Drives Conference (IEMDC), May 2015, pp. 234-239.
[5] S. Fang, H. Liu, H. Wang, H. Yang, and H. Lin, “High Power Density PMSM With Lightweight Structure and High-Performance Soft Magnetic Alloy Core,” IEEE Transactions on Applied Superconductivity, vol. 29, no. 2, pp. 1-5, March 2019.
[6] R. Cervantes et al., “A Compact Magnetic Field Cloaking Device,” p. 14.
[7] R. Sugouchi et al., “Conceptual Design and Electromagnetic Analysis of 2 MW Fully Superconducting Synchronous Motors With Superconducting Magnetic Shields for Turbo-Electric Propulsion System,” IEEE Transactions on Applied Superconductivity, vol. 30, no. 4, pp. 1-5, June 2020.
[8] Y. Terao, A. Seta, H. Ohsaki, H. Oyori, and N. Morioka, “Lightweight Design of Fully Superconducting Motors for Electrical Aircraft Propulsion Systems,” IEEE Transactions on Applied Superconductivity, vol. 29, no. 5, pp. 1-5, August 2019.
[9] M. Komiya et al., “Design Study of 10 MW REBCO Fully Superconducting Synchronous Generator for Electric Aircraft,” IEEE Transactions on Applied Superconductivity, vol. 29, no. 5, pp. 1-6, August 2019.
[10] L. A. Hall, “Survey of electrical resistivity measurements on 16 pure metals in the temperature range 0 to 273 K,” National Bureau of Standards, Gaithersburg, MD, NBS TN 365, 1968.
[11] M. D. Sumption, J. Murphy, M. Susner, and T. Haugan. “Performance metrics of electrical conductors for aerospace cryogenic motors, generators, and transmission cables.” Cryogenics 111 (2020): 103171.
[12] Y. Iwasa and K. R. Marken, “Case Studies in Superconducting Magnets: Design and Operational Issues,” Physics Today, vol. 48, no. 10, pp. 68-68, October 1995
[13] S. J. Lorant, “Superconducting shields for magnetic flux exclusion and field shaping.” Proc. 4th International Conference on Magnet Technology. Vol. 227. No. 197. 1972.
[14] D. B. Liarte et al. “Theoretical estimates of maximum fields in superconducting resonant radio frequency cavities: stability theory, disorder, and laminates.” Superconductor Science and Technology 30, 3 (2017): 033002.
[15] M. R. Presland et al. “Flux pinning and critical currents in superconducting thallium cuprates.” Cryogenics, 33, 5 (1993): 502-505.
[16] H. W. Neumuller et al. “Ion irradiation of layered BSCCO compounds: flux line pinning and evidence for 2-D behaviour.” Cryogenics, 33, 1 (1993): 14-20.
[17] Z. Sefrioui et al. “Crossover from a three-dimensional to purely two-dimensional vortex-glass transition in deoxygenated YBa 2 Cu 3 O 7-δ thin films.” Physical Review B, 60, 22 (1999): 15423.
[18] D. Talebi, M. C. Gardner, S. V. Sankarraman, A. Daniar, and H. A. Toliyat, “Electromagnetic Design Characterization of a Dual Rotor Axial Flux Motor for Electric Aircraft,” in 2021 IEEE International Electric Machines Drives Conference (IEMDC), May 2021, pp. 1-8.
[19] A. Al-Qarni, A. EL-Refaie, and F. Wu, “Impact of Machine Parameters on The Design of High Specific Power Permanent Magnet
Machines for Aerospace Applications,” in 2021 IEEE International Electric Machines Drives Conference (IEMDC), May 2021, pp. 1-8.
[20] S. Ullah, S. P. McDonald, R. Martin, and G. J. Atkinson, “A permanent magnet assisted switched reluctance machine for more electric aircraft,” in 2016 XXII International Conference on Electrical Machines (ICEM), September 2016, pp. 79-85
[21] A. Nasr, S. Hlioui, M. Gabsi, M. Mairie, and D. Lalevee, “Design Optimization of a Hybrid-Excited Flux-Switching Machine for Aircraft-Safe DC Power Generation Using a Diode Bridge Rectifier,” IEEE Transactions on Industrial Electronics, vol. 64, no. 12, pp. 9896-9904, December 2017.
[22] Carpenter Electrification, “Hiperco 50,” Hiperco 50 datasheet, 2020.
[23] https://htsdb.wimbush.eu/dataset/4256624.
[24] I. Kesgin, G. A. Levin, T. J. Haugan, and V. Selvamanickam, “Multifilament, copper-stabilized superconductor tapes with low alternating current loss,” Appl. Phys. Lett., vol. 103, no. 25, p. 252603, December 2013.
[25] A. Gandhi and L. Parsa, “Thrust optimization of a five-phase fault-tolerant flux-switching linear synchronous motor,” in IECON 2012 38th Annual Conference on IEEE Industrial Electronics Society, October 2012, pp. 2067-2073.
[26] Y. Li, D. Bobba, and B. Sarlioglu, “Design and Performance Characterization of a Novel Low-Pole Dual-Stator Flux-Switching Permanent Magnet Machine for Traction Application,” IEEE Transactions on Industry Applications, vol. 52, no. 5, pp. 4304-4314, September 2016.
[27] M. Zhang, F. Eastham, and W. Yuan, “Design and Modeling of 2G HTS Armature Winding for Electric Aircraft Propulsion Applications,” IEEE Transactions on Applied Superconductivity, vol. 26, no. 3, pp. 1-5, April 2016.
[28] D. Sumption, J. Murphy, M. Susner, and T. Haugan, “Performance metrics of electrical conductors for aerospace cryogenic motors, generators, and transmission cables,” Cryogenics, vol. 111, p. 103171, October 2020.
[29] V. Sokolovsky, V. Meerovich, M. Spektor, G. A. Levin, and I. Vajda, “Losses in Superconductors Under Non-Sinusoidal Currents and Magnetic Fields,” IEEE Transactions on Applied Superconductivity, vol. 19, no. 3, pp. 3344-3347, June 2009.
[30] G. Furman, M. Spektor, V. Meerovich, and V. Sokolovsky, “Losses in Coated Conductors Under Nonsinusoidal Currents and Magnetic Fields,” J Supercond Nov Magn, vol. 24, no. 1, pp. 1045-1051, January 2011.
[31] Selvamanickam, M. H. Gharahcheshmeh, A. Xu, E. Galstyan, L. Delgado, and C. Cantoni, “High critical currents in heavily doped (Gd,Y)Ba2Cu3Ox superconductor tapes,” Appl. Phys. Lett., vol. 106, no. 3, p. 032601, January 2015.
[32] DE-FOA-0002238: Aviation-class synergistically cooled electric-motors with integrated drives (ASCEND)”, Department of Energy, Advanced Research Projects Agency Energy, Dec. 16, 2019

### References for Second Example

[1] C. L. Bowman, J. L. Felder, and Ty. V. Marien, “Turbo- and Hybrid-Electrified Aircraft Propulsion Concepts for Commercial Transport,” in 2018 AIAA/IEEE Electric Aircraft Technologies Symposium (EATS), July 2018, pp. 1-8.
[2] M. T. Fard, J. He, H. Huang, and Y. Cao, “Aircraft Distributed Electric Propulsion Technologies—A Review,” IEEE Transactions on Transportation Electrification, vol. 8, no. 4, pp. 4067-4090, December 2022.
[3] R. C. Bolam, Y. Vagapov, and A. Anuchin, “A Review of Electrical Motor Topologies for Aircraft Propulsion,” in 2020 55th International Universities Power Engineering Conference (UPEC), September 2020, pp. 1-6.
[4] E. Sayed et al., “Review of Electric Machines in More-/Hybrid-/Turbo-Electric Aircraft,” IEEE Transactions on Transportation Electrification, vol. 7, no. 4, pp. 2976-3005, December 2021.
[5] Y. Terao, W. Kong, H. Ohsaki, H. Oyori, and N. Morioka, “Electromagnetic Design of Superconducting Synchronous Motors for Electric Aircraft Propulsion,” IEEE Transactions on Applied Superconductivity, vol. 28, no. 4, pp. 1-5, June 2018.
[6] K. Ozaki et al., “Conceptual Design of Superconducting Induction Motors Using REBa2Cu3Oy Superconducting Tapes for Electric Aircraft,” IEEE Transactions on Applied Superconductivity, vol. 30, no. 4, pp. 1-5, June 2020.
[7] W. Zhao, J. Ji, G. Liu, Y. Du, and M. Cheng, “Design and Analysis of a New Modular Linear Flux-Reversal Permanent-Magnet Motor,” IEEE Transactions on Applied Superconductivity, vol. 24, no. 3, pp. 1-5, June 2014.
[8] H. Yang, H. Lin, Z. Q. Zhu, S. Lyu, and Y. Liu, “Design and Analysis of Novel Asymmetric-Stator-Pole Flux Reversal PM Machine,” IEEE Transactions on Industrial Electronics, vol. 67, no. 1, pp. 101-114, January 2020.
[9] R. Sugouchi et al., “Conceptual Design and Electromagnetic Analysis of 2 MW Fully Superconducting Synchronous Motors With Superconducting Magnetic Shields for Turbo-Electric Propulsion System,” IEEE Transactions on Applied Superconductivity, vol. 30, no. 4, pp. 1-5, June 2020.
[10] L. Wera, J.-F. Fagnard, D. K. Namburi, Y. Shi, B. Vanderheyden, and P. Vanderbemden, “Magnetic Shielding Above 1 T at 20 K With Bulk, Large Grain YBCO Tubes Made by Buffer-Aided Top Seeded Melt Growth,” IEEE Transactions on Applied Superconductivity, vol. 27, no. 4, pp. 1-5, June 2017.
[11] K. Hogan, J.-F. Fagnard, L. Wera, B. Vanderheyden, and P. Vanderbemden, “Bulk superconducting tube subjected to the stray magnetic field of a solenoid,” Supercond. Sci. Technol., vol. 31, no. 1, p. 015001, November 2018.
[12] A. Gandhi, A. Mohammadpour, S. Sadeghi, and L. Parsa, “Doubled-sided FRLSM for long-stroke safety-critical applications,” in IECON 2011-37th Annual Conference of the IEEE Industrial Electronics Society, November 2011, pp. 4186-4191.
[13] R. Cervantes et al., “A Compact Magnetic Field Cloaking Device,” p. 14.
[14] V. Selvamanickam, M. H. Gharahcheshmeh, A. Xu, Y. Zhang, and E. Galstyan, “Critical current density above 15 MA cm-2 at 30 K, 3 T in 2.2 μm thick heavily-doped (Gd,Y)Ba 2 Cu 3 O×superconductor tapes,” Supercond. Sci. Technol., vol. 28, no. 7, p. 072002, July 2015.
[15] I. Kesgin, G. A. Levin, T. J. Haugan, and V. Selvamanickam, “Multifilament, copper-stabilized superconductor tapes with low alternating current loss,” Appl. Phys. Lett., vol. 103, no. 25, p. 252603, December 2013.
[16] S. Fang, H. Liu, H. Wang, H. Yang, and H. Lin, “High Power Density PMSM With Lightweight Structure and High-Performance Soft Magnetic Alloy Core,” IEEE Transactions on Applied Superconductivity, vol. 29, no. 2, pp. 1-5, March 2019.
[17] S. Saeidabadi, C. Kovacs, A. Usman, T. J. Haugan, K. Corzine, and L. Parsa,
“Flux Switching Machines- for All-Electric Aircraft Applications,” in 2022 International Conference on Electrical Machines (ICEM), September 2022, pp. 1430-1436.
[18] Carpenter Electrification, “Hiperco 50,” Hiperco 50 datasheet, 2020.
[19] S. Saeidabadi, L. Parsa, K. A. Corzine, C. J. Kovacs, and T. J. Haugan, “A High Power Density Flux Switching Machine with Superconducting Field Coils and Shields for Aircraft Applications,” IEEE International Electric Machines and Drives Conference, San Francisco CA, 2023.
[20] M. Sumption, J. Murphy, M. Susner, and T. Haugan, “Performance metrics of electrical conductors for aerospace cryogenic motors, generators, and transmission cables,” 2020.
[21] M. Zhang, F. Eastham, and W. Yuan, “Design and Modeling of 2G HTS Armature Winding for Electric Aircraft Propulsion Applications,” IEEE Transactions on Applied Superconductivity, vol. 26, no. 3, pp. 1-5, April 2016.
[22] J. ter Harmsel, S. Otten, M. Dhallé, and H. ten Kate, “Magnetization loss and transport current loss in ReBCO racetrack coils carrying stationary/

### CONCLUSION

This concludes the description of the preferred embodiments of the present disclosure. The foregoing description of the preferred embodiment has been presented for the purposes of illustration and description. It is not intended to be exhaustive or to limit the disclosure to the precise form disclosed. Many modifications and variations are possible in light of the above teaching. It is intended that the scope of rights be limited not by this detailed description, but rather by the claims appended hereto.

1. An electric machine, comprising:
an air core stator comprising field coils and armature coils, wherein the field coils comprise a superconductor; and
at least one magnetically salient rotor coupled to the air core stator.

2. The electric machine of claim 1, further comprising a superconducting shielding between poles of the at least one rotor.

3. The electric machine of claim 1, wherein:
the at least one rotor further comprises:
a first rotor comprising first rotor poles and first non-magnetic slots between the first rotor poles; and
a second rotor comprising second rotor poles and second non-magnetic slots between the second rotor poles, the first rotor and the second rotor comprising a material having a lower reluctance than air; wherein the second rotor is positioned concentrically or axially inside the first rotor such that the second rotor poles face the first non-magnetic slots;
the air core stator:
is disposed between the first rotor and the second rotor,
comprises a core consisting essentially of air; and
contains a plurality of pairs of coils attached to the stator, each pair comprising at least one of the field coils magnetically coupled to one of the armature coils.

4. The electric machine of claim 3, wherein the pairs of coils are attached to the air core stator such that a magnetic flux generated by each of the pairs of coils is diverted into at least one of the first rotor poles or at least one of the second rotor poles.

5. The electric machine of claim 3, further comprising superconducting shielding placed at interpole locations between the rotor poles of the at least one rotor.

6. The electric machine of claim 5, further comprising the superconducting shielding covering at least the first non-magnetic slots or the second non-magnetic slots between the rotor poles, so as to aid diversion of the magnetic flux into the rotor poles.

7. The electric machine of claim 5, wherein the superconducting shielding comprises a tape comprising at least one of a machined bulk melt textured solid high temperature superconductor (HTS), pressed and sintered polycrystalline HTS, a laminated HTS coated-conductor composite stack, or a heterostructure comprising a non-superconductor layer between superconductor layers.

8. The electric machine of claim 5, wherein:
the superconducting shielding comprises a layer or tape having a solid superconductive cross-section perpendicular to a magnetic flux in interpole regions, comprising the non-magnetic slots between the rotor poles, to prevent the magnetic flux leaking through the superconductive shielding, and
any gaps in the superconductive shielding perpendicular to the magnetic flux in the interpole regions are smaller than a penetration depth of the superconducting shielding to prevent penetration of the magnetic flux into the gaps.

9. The electric machine of claim 5, wherein the superconducting shielding comprises a high temperature superconductor (HTS) comprising at least one of a cuprate, an iron-based superconductor, or MgB₂ having a critical temperature above 20 K.

10. A motor comprising the electric machine of claim 3, further comprising:
a circuit connected to the field coils and the armature coils, wherein, for each of the pairs of coils:
the armature coils generate magnetic flux in response to a first current inputted from the circuit, and
the field coil generate a stator magnetic pole aligned along a circumferential direction of the air core stator in response to a second current inputted from the circuit, the stator magnetic pole causing a diversion of the magnetic flux into the at least one of first rotor poles or the second rotor poles, and
the diversion of the magnetic flux along the stator magnetic poles and into the at least one of the rotor poles causes a rotation of at least one of the first rotor or the second rotor so as to increase alignment of at least one of the rotor poles with the stator magnetic pole, thereby outputting torque to a component coupled to the rotation.

11. (canceled)

12. An electric generator comprising the electric machine of claim 3, further comprising a circuit connected to the field coils and the armature coils, wherein, for each of the pairs of the coils,
the field coils form stator magnetic poles aligned along a circumferential direction of the stator, the stator magnetic poles generating a magnetic flux, in response to a first current inputted from the circuit, and
a second current is induced in the armature coils and outputted to the circuit in response to an interaction of the rotor poles with the magnetic flux caused by a rotation of at least one of the first rotor or the second rotor.

13. The electric machine of claim 3, further comprising a circuit connected to the pairs of coils generate a magnetic flux and switching the magnetic flux between the rotor poles in response to sequential excitation of the pairs of coils by the circuit; and
wherein the coils are positioned and the sequential excitation are such that the switching comprises a reversal of the magnetic flux so that the linkage of the magnetic flux has a polarity reversing periodically between:
a first direction from one of the first rotor poles to one of the second rotor poles, to
a second direction from one of the second rotor poles to one of the first rotor poles.

14. (canceled)

15. (canceled)

16. The electric machine of claim 1, further comprising a cryogenic cooling system thermally coupled to the air core stator for cooling the armature coil and the field coil to a temperature of 20 Kelvin or above; and
wherein the cooling system comprises a plurality of coolant manifolds mechanically supporting each of the pairs of coils, wherein each of the coolant manifolds comprise an electrically insulating polymer separating and supporting the field coils and armature coil in each pair and a coolant system thermally coupling the coils to a flowing coolant.

17. (canceled)

18. The electric machine of claim 3, wherein:
the first rotor, the second rotor, and the stator comprise concentric annular rings about a central axis,
for each of the pairs of the coils,
the field coil comprises a field winding disposed within, surrounded by, or inside an opening of the armature coil comprising an armature winding,
armature wires of the armature winding are concentric about an armature axis oriented along a radial direction from the central axis, and
field wires of the field winding are concentric about a field axis oriented along a circumferential direction perpendicular to the radial direction, and
a core of the field coil comprises or consists essentially of air, or the field coil is coiled around air, and
each of the pairs of coils comprises a plurality of the field coils disposed with, surrounded by, or inside the opening of the armature coil, and
the first rotor poles and the second rotor poles comprise teeth spaced a half pitch apart.

19. (canceled)

20. The electric machine of claim 3, comprising:
first rotor poles and 20 second rotor poles and 15 pairs of the coils, or
7 first rotor poles and 7 second rotor poles and 6 pairs of the coils, or
16 first rotor poles and 16 second rotor poles and 12 pairs of the coils, or
12 first rotor poles and 12 second rotor poles and 9 pairs of the coils.

21. The electric machine of claim 3, further comprising a circuit connected to the pairs of coils, wherein:
the armature coil in each of the pairs of the coils, associated with a given one of a plurality of phases excited by the circuit, are electrically connected in series for simultaneous excitation by the circuit with a current, and
the current in each of the phases is out of phase with the current in another of the phases, and
comprising a number Nₚₒₗₑ of the rotor poles, a number Nₛₗₒₜ of the pairs of coils, and a number m of the phases, wherein
$${N}_{pole} = {N}_{slot} ( 2 \pm \frac{n}{2 m} )$$

22. (canceled)

23. (canceled)

24. The electric machine of claim 1, wherein the electric machine comprises a flux switching machine comprising a plurality of the at least one rotor and the air core stator between a pair of the rotors.

26. The electric machine of claim 24, wherein the flux switching machine comprises a flux reversal machine.

27. The electric machine of claim 1, wherein the electric machine comprises an axial machine wherein magnetic flux generated by the coils is along an axial direction parallel to an axis of rotation of the rotors.

28. (canceled)
